(19) United States
(12) Patent Application Publication
(10) Pub. No.: US 2024/0202464 A1
(43) Pub. Date: Jun. 20, 2024

(54) ITERATIVE CONTEXT-BASED GENERATIVE ARTIFICIAL INTELLIGENCE

(71) Applicant: C3.ai, Inc., Redwood City, CA (US)

(72) Inventors: Louis Poirier, Paris (FR); Romain Juban, San Francisco, CA (US); Yushi Homma, Santa Clara, CA (US); Riyad Muradov, Foster City, CA (US); Michael Haines, San Mateo, CA (US)

(21) Appl. No.: 18/542,572

(22) Filed: Dec. 15, 2023

Related U.S. Application Data
(60) Provisional application No. 63/433,124, filed on Dec. 16, 2022.
(60) Provisional application No. 63/446,792, filed on Feb. 17, 2023.
(60) Provisional application No. 63/492,133, filed on Mar. 24, 2023.

(51) Int. Cl. G06F 40/40

(52) U.S. Cl. CPC G06F 40/40

(57) ABSTRACT

Systems and methods managing a plurality of agents to generate a response to a query using a multimodal model. An example method uses the plurality of agents to iteratively determine subsequent outputs of the multimodal model satisfies the query. It can generate a respective context associated with a respective output of the multimodal model. And determine, by the multimodal model based on the respective context, whether the respective subsequent output satisfies the query.

### CROSS-REFERENCE TO RELATED APPLICATIONS

The present application claims the benefit of U.S. Provisional Patent Application Ser. No. 63/433,124 filed Dec. 16, 2022 and entitled “Unbounded Data Model Query Handling and Dispatching Action in a Model Driven Architecture,” U.S. Provisional Patent Application Ser. No. 63/446,792 filed Feb. 17, 2023 and entitled “System and Method to Apply Generative AI to Transform Information Access and Content Creation for Enterprise Information Systems,” and U.S. Provisional Patent Application Ser. No. 63/492,133 filed Mar. 24, 2023 and entitled “Iterative Context-based Generative Artificial Intelligence,” each of which is hereby incorporated by reference herein.

### TECHNICAL FIELD

This disclosure pertains to artificial intelligence and machine learning. More specifically, this disclosure pertains to iterative context-based generative artificial intelligence systems.

### BACKGROUND

Under traditional approaches, computing systems routinely store information that can be accessed, searched, and retrieved. For example, databases of information can be searched and accessed by various users and applications. Machine learning techniques can also classify and label such information to perform predictions and generate analytics. However, existing machine learning systems can have limited functionality (e.g., limited to classification and labeling) and cannot intelligently and reliably respond to natural language inputs.

### SUMMARY

A claimed solution rooted in computer technology overcomes problems specifically arising in the realm of computer technology. Various embodiments of the present disclosure include systems, methods, and non-transitory computer-readable medium configured to iteratively employ multimodal models (e.g., large language models) to generate a deterministic response. A supervisor service can manage a series of agents and/or be distributed among the agents to communicate that generate output with one more multimodal models (e.g., large language models) that include context information for a given query or request. The supervisor service uses the generated output that includes the context information to iteratively repeat assessing the results with the multimodal models (e.g., large language models) to determine whether the output satisfies a query. The iteratively context-based generative query handling by the supervisor service includes dynamic workflows to produce hallucination-free, traceable, and deterministic responses.

These and other features of the systems, methods, and non-transitory computer readable medium disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 depicts a diagram of an example network system for iterative generative artificial intelligence according to some embodiments.

FIG. 2 depicts a diagram of an example iterative context-based generative artificial intelligence system according to some embodiments.

FIG. 3 depicts a diagram of an example architecture and an example method of operation of an iterative context-based generative artificial intelligence system according to some embodiments.

FIG. 4 depicts a flowchart of an example method of iterative context-based generative artificial intelligence according to some embodiments.

FIG. 5 depicts a flowchart of an example method of an iteration of an iterative process for determining whether a multimodal model output satisfies an initial input according to some embodiments.

FIG. 6 depicts a flowchart of an example method of generating and using prompts in an iterative context-based generative artificial intelligence process according to some embodiments.

FIG. 7 depicts a flowchart of an example method of iterative context-based generative artificial intelligence using stopping conditions according to some embodiments.

FIGS. 8A-E depict diagrams of example prompts for iterative context-based generative artificial intelligence according to some embodiments.

FIG. 9 depicts a flowchart of an example method of iterative context-based generative artificial intelligence including generating and using context-based synthetic output according to some embodiments.

FIG. 10 depicts a flowchart of an example method of iterative context-based generative artificial intelligence including generating and using prompts and synthesized data according to some embodiments.

FIG. 11 depicts a flowchart of an example method of iterative context-based generative artificial intelligence including prompt templates according to some embodiments.

FIG. 12 depicts a flowchart of an example method of iterative context-based generative artificial intelligence using retriever models and multimodal models according to some embodiments

FIG. 13 depicts a diagram of an example graph of interactions between components of an iterative context-based generative artificial intelligence system according to some embodiments.

FIGS. 14A-C depict a flowchart of an example method of iterative context-based generative artificial intelligence according to some embodiments.

FIG. 15 is a diagram of an example computer system for implementing the features disclosed herein according to some embodiments.

### DETAILED DESCRIPTION

Conventional generative artificial intelligence processes often present faulty or biased information, cannot effectively handle complex inputs, and like traditional machine learning systems, also fail to interact effectively with other machine learning systems or effectively leverage information across different domains. These problems, as well as those discussed above, are addressed by the iterative context-based generative artificial intelligence systems and processes discussed herein.

The iterative context-based generative artificial intelligence systems and methods described herein can, among other things, provide results that are more accurate and less biased than conventional generative artificial intelligence solutions, and can effectively leverage information and machine learning-based insights (or, simply, insights) across different domains. These iterative context-based generative artificial intelligence systems can use context-based iterations that allow models (e.g., multimodal machine learning models, large language models) to effectively learn from each other based on context generated during an iterative process. Accordingly, iterative context-based generative artificial intelligence processes do not simply rely on generic probability distributions and single-pass solutions (e.g., traditional large language model-based systems) and can respond more intelligently with improved validation to inputs than conventional generative artificial intelligence solutions.

The iterative context-based generative artificial intelligence systems can effectively handle complex inputs (e.g., instruction sets, queries, natural language inputs or other human-readable inputs, machine-readable inputs) from users, software (e.g., artificial intelligence applications), and machines. For example, iterative context-based generative artificial intelligence systems do not rely on a single pass to return a result, but rather can iteratively communicate between different models and different types of models until an acceptable result (e.g., “answer”) is generated, which is particularly useful for complex inputs. Iterative context-based generative artificial intelligence systems disclosed herein include novel techniques to enhance quality of output, improve likelihood of relevance, reduce the likelihood of presenting faulty and biased information, and prevent other potential technical issues. For example, supervisory functions of the iterative context-based generative artificial intelligence systems can prevent infinite loops and other technical problems.

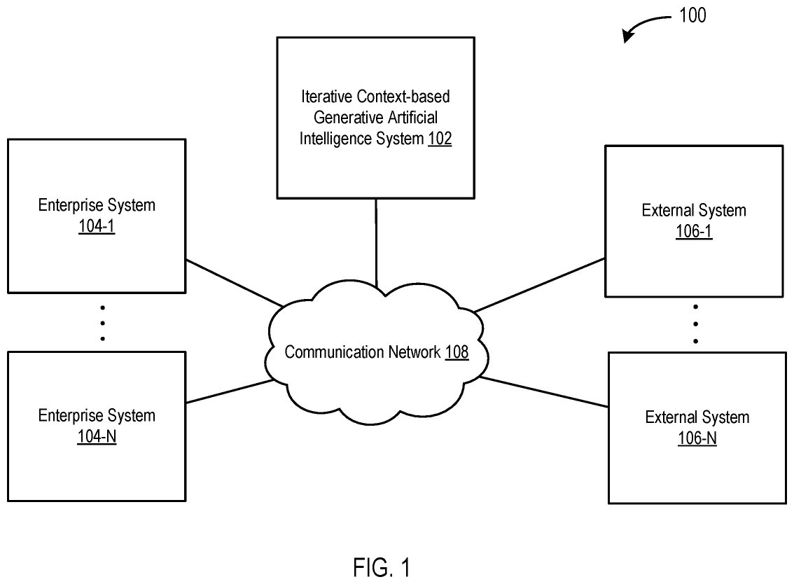

FIG. 1 depicts a diagram 100 of an example network system for iterative generative artificial intelligence according to some embodiments. In the example of FIG. 1, the network system includes an iterative context-based generative artificial intelligence system 102, enterprise systems 104-1 to 104-N (individually, the enterprise system 104, collectively, the enterprise systems 104), external systems 106-1 to 106-N (individually, the external system 106, collectively, the external systems 106), and a communication network 108.

The iterative context-based generative artificial intelligence system 102 may function to iteratively generate machine learning model inputs and outputs to generate a final output (e.g., “answer”) in response to a complex input. In various embodiments, functionality of the iterative context-based generative artificial intelligence system 102 may be performed by one or more servers (e.g., a cloud-based server) and/or other computing devices. The iterative context-based generative artificial intelligence system 102 may be implemented using a model-driven architecture.

In various implementations, the iterative context-based generative artificial intelligence system 102 can provide a variety of different technical features, such as effectively handling and generating complex natural language inputs and outputs, generating synthetic data (e.g., supplementing customer data obtained during an onboarding process, or otherwise filling data gaps), generating source code (e.g., application development), generating applications (e.g., artificial intelligence applications), providing cross-domain functionality, as well as a myriad of other technical features that are not provided by traditional systems. As used herein, synthetic data can refer to content generated on-the-fly (e.g., by large language models) as part of the iterative processes described herein. Synthetic data can also include non-retrieved ephemeral content (e.g., temporary data that does not subsist in a database), as well as combinations of retrieved information, queried information, model outputs, and/or the like.

The iterative context-based generative artificial intelligence system 102 can provide and/or enable an intuitive non-complex interface to rapidly execute complex user requests with improved access, privacy, and security enforcement. The iterative context-based generative artificial intelligence system 102 can include a human computer interface for receiving natural language queries and presenting relevant information with predictive analysis from the enterprise information environment in response to the queries. For example, the iterative context-based generative artificial intelligence system 102 can understand the language, intent, and/or context of a user natural language query. The iterative context-based generative artificial intelligence system 102 can execute the user natural language query to discern relevant information from an enterprise information environment to present to the human computer interface (e.g., in the form of an “answer”).

Generative artificial intelligence models (e.g., large language models) of the iterative context-based generative artificial intelligence system 102 can interact with other models (e.g., retriever models) to iteratively retrieve and process information from various data sources. For example, data sources can store data records and/or segments of data records which may be identified by the iterative context-based generative artificial intelligence system 102 based on embedding values (e.g., vector values associated with data records and/or segments). Data records can include unstructured data records (e.g., documents and text data that is stored on a file system in a format such as PDF, DOCX, .MD, HTML, TXT, PPTX, image files, audio files, video files, application outputs, and the like), structured data records (e.g., database tables or other data records stored according to a data model or type system), timeseries data records (e.g., sensor data, artificial intelligence application insights), and/or other types of data records (e.g., access control lists). Unstructured data and structured data can be retrieved from one or more data stores. In some embodiments, an agent can use embeddings (e.g., vectors stored in a vector store) when retrieving information. For example, the agent can use a similarity evaluation or search to find relevant data records based on k-nearest neighbor, where embeddings that are closer to each other are more likely relevant.

The iterative context-based generative artificial intelligence system 102 can generate context-based synthetic output based on retrieved information from one or more retriever models. For example, the retriever models can provide additional retrieved information to the multimodal models (e.g., large language models) to generate additional context-based synthetic output until context validation criteria is satisfied. Once the validation criteria are satisfied, the iterative context-based generative artificial intelligence system 102 can output the additional context-based synthetic output as a result or instruction set (collectively, “answers”).

The iterative context-based generative artificial intelligence system 102 provides transformative context-based intelligent generative results. For example, the iterative context-based generative artificial intelligence system 102 can process inputs from enterprise users using a natural language interface to rapidly locate, retrieve, and present relevant data across the entire corpus of an enterprise's information systems.

As discussed herein, the iterative context-based generative artificial intelligence system 102 can handle both machine-readable inputs (e.g., compiled code, structured data, and/or other types of formats that can be processed by a computer) and human-readable inputs. Inputs can also include complex inputs, such as inputs including “and,” “or”, inputs that include different types of information to satisfy the input (e.g., data records, text documents, database tables, and artificial intelligence insights), and/or the like. In one example, a complex input may be “How many different engineers has John Doe worked with within his engineering department?” This may require the iterative context-based generative artificial intelligence system 102 to identify John Doe in a first iteration, identify John Doe's department in a second iteration, determine the engineers in that department in a third iteration, then determine in a fourth iteration which of those engineers John Doe has interacted with, and then finally combine those results, or portions thereof, to generate the final answer to the query. More specifically, the iterative context-based generative artificial intelligence system 102 can use portions of the results of each iteration to generate contextual information (or, simply, context) which can then inform the subsequent iterations.

The enterprise systems 104 include enterprise applications (e.g., artificial intelligence applications), enterprise datastores, client systems, and/or other systems of an enterprise information environment. As used herein, an enterprise information environment can include one or more networks (e.g., cloud, on premise, air-gapped or otherwise) of enterprise systems (e.g., enterprise applications, enterprise datastores), client systems (e.g., computing systems for access enterprise systems). The enterprise systems 104 can include disparate computing systems, applications, and/or datastores, along with enterprise-specific requirements and/or features. For example, enterprise systems 104 can include access and privacy controls. For example, a private network of an organization may comprise an enterprise information environment that includes various enterprise systems 104. Enterprise systems 104 can include, for example, CRM systems, EAM systems, ERP systems, FP&A systems, HRM systems, and SCADA systems. Enterprise systems 104 can include or leverage artificial intelligence applications and artificial intelligence applications may leverage enterprise systems and data. Enterprise systems 104 can include data flow and management of different processes (e.g., of one or more organizations) and can provide access to systems and users of the enterprise while preventing access from other systems and/or users. It will be appreciated that, in some embodiments, references to enterprise information environments can also include enterprise systems, and references to enterprise systems can also include enterprise information environments. In various embodiments, functionality of the enterprise systems 104 may be performed by one or more servers (e.g., a cloud-based server) and/or other computing devices.

The external systems 106 include applications, datastores, and systems that are external to the enterprise information environment. In one example, the enterprise systems 104 may be a part of an enterprise information environment of an organization that cannot be accessed by users or systems outside that enterprise information environment and/or organization. Accordingly, the example external systems 106 may include Internet-based systems, such as news media systems, social media systems, and/or the like, that are outside the enterprise information environment. In various embodiments, functionality of the external systems 104 may be performed by one or more servers (e.g., a cloud-based server) and/or other computing devices.

The communications network 108 may represent one or more computer networks (e.g., LAN, WAN, air-gapped network, cloud-based network, and/or the like) or other transmission mediums. The communication network 108 may provide communication between the systems, modules, engines, generators, datastores, and/or other components described herein. In some embodiments, the communication network 108 includes one or more computing devices, routers, cables, buses, and/or other network topologies (e.g., mesh, and the like). The communication network 108 may be wired and/or wireless. In various embodiments, the communication network 108 may include local area networks (LANs), wide area networks (WANs), the Internet, and/or one or more networks that may be public, private, IP-based, non-IP based, air-gapped, and so forth.

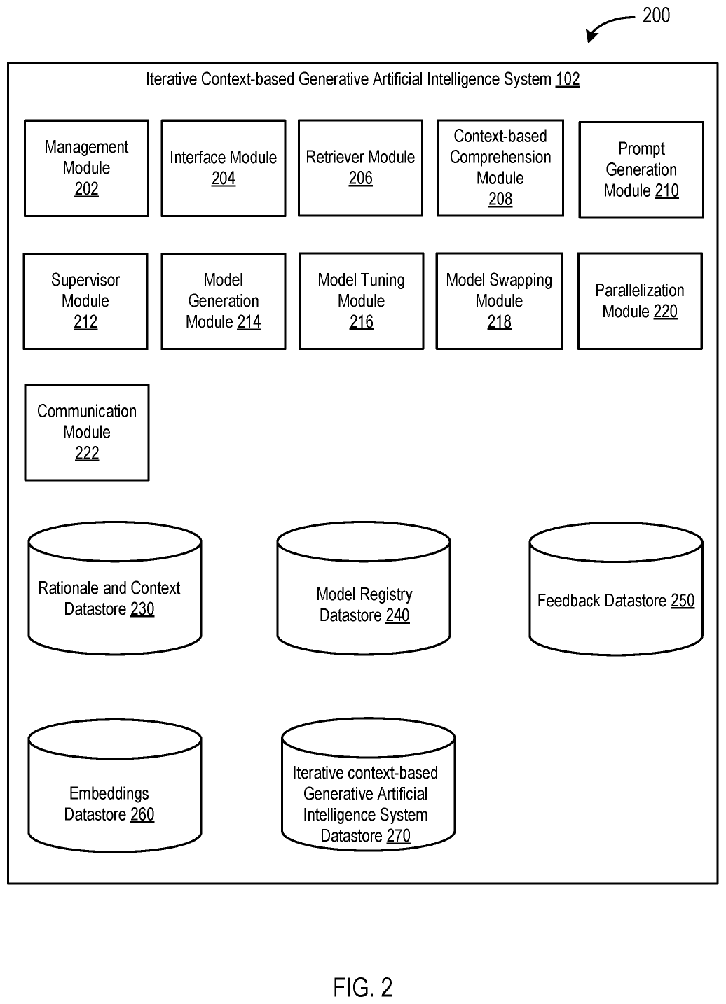

FIG. 2 depicts a diagram 200 of an example iterative context-based generative artificial intelligence system 102 according to some embodiments. In the example of FIG. 2, the iterative context-based generative artificial intelligence system 102 includes a management module 202, an interface module 204, a retriever module 206, a context-based comprehension module 208, a prompt generation module 210, a supervisor module 212, a model generation module 214, a model swapping module 218, a parallelization module 220, a communication module 222, rationale and context datastore 230, a model registry datastore 240, a feedback datastore 250, an embeddings datastore 260, and an iterative context-based generative artificial intelligence system datastore 270.

The management module 202 can function to manage (e.g., create, read, update, delete, or otherwise access) data associated with the iterative context-based generative artificial intelligence system 102. The management module 202 can store or otherwise manage or store in any of the datastores 230-270, and/or in one or more other local and/or remote datastores. It will be appreciated that that datastores can be a single datastore local to the iterative context-based generative artificial intelligence system 102 and/or multiple datastores remote to the iterative context-based generative artificial intelligence system 102. In some embodiments, the datastores described herein comprise one or more local and/or remote datastores. The management module 202 can perform operations manually (e.g., by a user interacting with a GUI) and/or automatically (e.g., triggered by one or more of the modules 204-222). Like other modules described herein, some or all the functionality of the management module 202 can be included in and/or cooperate with one or more other modules, systems, and/or datastores.

The interface module 204 can function to receive inputs (e.g., complex inputs) from users and/or systems. The interface module 204 can also generate and/or transmit outputs. Inputs can include system inputs and user inputs. For example, inputs can include instructions sets, queries, natural language inputs or other human-readable inputs, machine-readable inputs, and/or the like. Similarly, outputs can also include system outputs and human-readable outputs.

An input (e.g., request, prompt, query) can be input various natural forms for easy human interaction (e.g., basic text box interface, image processing, voice activation, and/or the like) and processed to rapidly find relevant and responsive information.

The interface module 204 can function to generate graphical user interface components (e.g., server-side graphical user interface components) that can be rendered as complete graphical user interfaces on the iterative context-based generative artificial intelligence system 102 and/or other systems. For example, the interface module 204 can function to present an interactive graphical user interface for displaying and receiving information. Visualizations can be three dimensional (3D) and include interactive elements related to the deterministic output, for example, that enable executing instructions (e.g., transmissions, control system commands, etc.), drilling into traceability, activating application features, and the like.

The retriever module 206 functions to receive inputs, retrieve information (e.g., data records) from disparate data sources (e.g., an embeddings index, enterprise systems, external systems, and/or the like) in disparate data formats (e.g., text documents, database tables, APIs, machine learning-based insights or other application output, and/or the like), and output information (e.g., the retrieved information, or a subset thereof). In some implementations, the retriever module 206 comprises one or more machine learning models, such as deep learning models, neural network models, transformer-based models, and the like. The retriever module 206 may also generate outputs that are human-readable and/or machine-readable.

In some implementations, the retriever module 206 includes models that can convert (or, transform) an image, database table, and/or other non-text input, into text format (e.g., natural language) or other format suitable for processing by multimodal models and/or context-based comprehension modules (e.g., context-based comprehension module 208, context-based comprehension module 306). Model training can be implemented continuously, asynchronously, with feedback (e.g., re-enforcement learning, etc.), and the like. The retriever module 206 can use different models for different domains. For example, different domains may correspond to different industries (e.g., aerospace, defense), different technological environments (e.g., on premise, air-gapped, cloud-native), different enterprises or organizations, and/or the like. Accordingly, for example, the retriever module 206 can use a particular model for a particular domain (e.g., a model trained on aerospace-specific datasets) and use another model for another domain (e.g., a model trained on defense-specific datasets), and so forth.

The context-based comprehension module 208 can function to cooperate with the retriever module 206 (or retriever models thereof) to iteratively process inputs to determine output results or answers, determine context and rationales for informing subsequent iterations, and determine whether the context-based comprehension module 208 requires additional information to determine answers. For example, the retriever module 206 may receive a query and retrieve associated information, which it can then provide to the context-based comprehension module 208 for processing. In some embodiments, the context-based comprehension module 208 can receive transformed queries (e.g., a query that was transformed by the retriever module 206). In some embodiments, the context-based comprehension module 208 may output information (e.g., answers or additional queries) in a natural language format.

In some embodiments, the context-based comprehension module 208 comprises one or more large language models. The one or more large language models may be configured to generate and process context, as well as the other outputs described herein. The context-based comprehension module 208 may also include one or more large language models that pre-processes inputs (e.g., a user query) prior to inputs being provided to the retriever module 206. The context-based comprehension module 208 may also include one or more large language models that process outputs from other models and modules (e.g., the retriever module 206). The context-based comprehension module may also include another large language model for processing answers from one large language model into a format more consistent with an answer (e.g., an answer natural language format) that can be transmitted to a user or system that provided the initial query. The context-based comprehension module 208 may also notify users and systems if it cannot find an answer (e.g., as opposed to presenting an answer that is likely faulty or biased).

Features of one or more large language models of the context-based comprehension module 208 can define conditions or functions that determine if more information is needed to satisfy the initial input or if there is enough information to satisfy the initial input. The large language models of the context-based comprehension module 208 may also define stopping conditions that indicate a stopping threshold condition indicating a maximum number of iterations that may be performed before the iterative process is terminated.

The context-based comprehension module 208 can generate and store rationales and contexts (e.g., in datastore 310). The rationale may be the reasoning used by the context-based comprehension module 208 to determine the output (e.g., natural language output, an indication that it needs more information, an indication that it can satisfy the initial input). The context-based comprehension module 208 may generate context based on the rationale. In some implementations, the context comprises a concatenation and/or annotation of one or more segments of data records, and/or embeddings associated therewith, along with a mapping of the concatenations and/or annotations. For example, the mapping may indicate relationships between different segments, a weighted or relative value associated with the different segments, and/or the like. The rational and/or context may be included in the prompts described elsewhere herein.

In some embodiments, the context-based comprehension module 208 includes a query and rational generator (e.g., query and rationale generator 312) that generates queries for models (e.g., large language models, other machine learning models) and/or generates and stores the rationales and contexts (e.g., in the rationale and context datastore 230). The query and rational generator can function to process, extract and/or transform different types of data (e.g., text, database tables, images, video, code, and/or the like). For example, the query and rational generator may take in a database table as input and transform it into natural language describing the database table which can then be provided to the one or more other models (e.g., large language models) of the context-based comprehension module 208, which can then process that transformed input to “answer,” or otherwise satisfy a query. In some implementations, the query and rational generator includes models that can convert (or, transform) an image, database table, and/or other non-text input, into text format (e.g., natural language).

The context-based comprehension module 208 can use different models for different domains. For example, as discussed above, different domains may correspond to different industries (e.g., aerospace, defense), different technological environments (e.g., air-gapped, cloud-native), different enterprises or organizations, and/or the like. Accordingly, for example, the context-based comprehension module 208 can use a particular multimodal model for a particular domain (e.g., a large language model trained on aerospace-specific datasets) and use another multimodal model for another domain (e.g., a large language model trained on defense-specific datasets), and so forth.

In some embodiments, the context-based comprehension module 208 includes some or all of the functionality and/or structure of the context-based comprehension module 306, described further below. For example, the context-based comprehension module 208 may be the same as the context-based comprehension module 306. Similarly, in some embodiments, the context-based comprehension module 306 may include some or all of the functionality and/or structure of the context-based comprehension module 208.

In an example embodiment, a large language model is a deep learning model (e.g., generated by a deep learning algorithm) that can recognize, summarize, translate, predict, and/or generate text and other content based on knowledge gained from massive datasets. Large language models may comprise transformer-based models. Large language models can process vast amounts of data, leading to improved accuracy in prediction and classification tasks. The large language models can use this information to learn patterns and relationships, which can help them make improved predictions and groupings relative to other machine learning models.

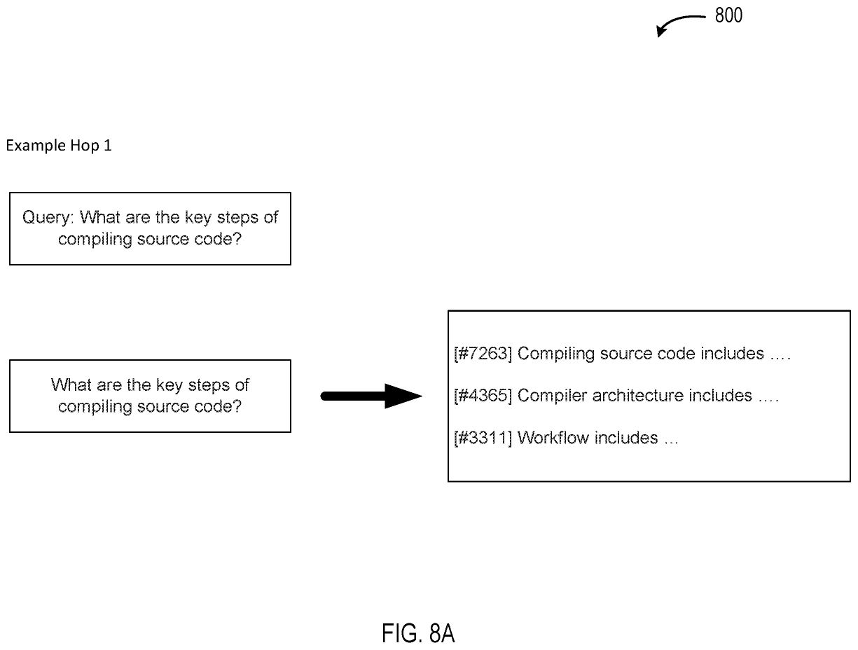

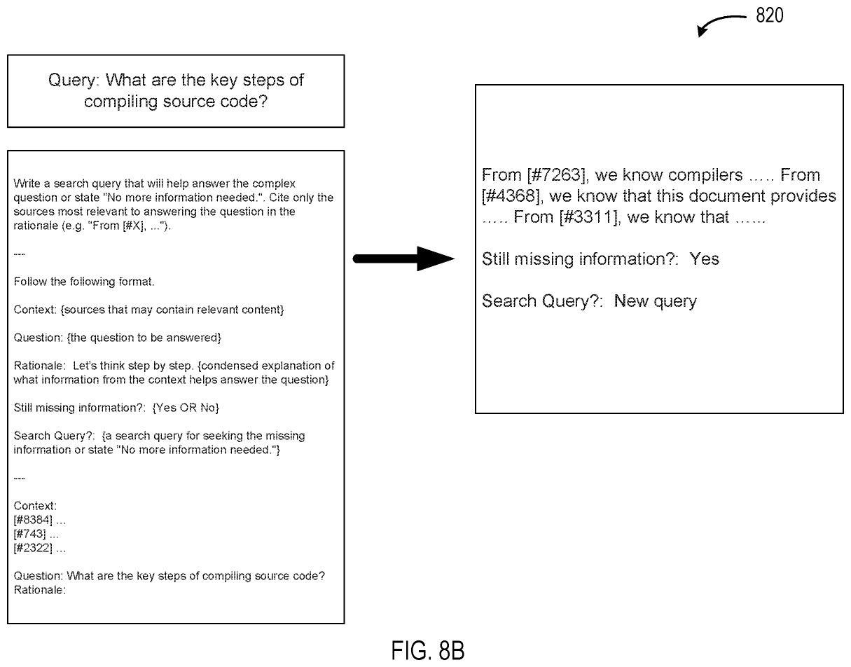

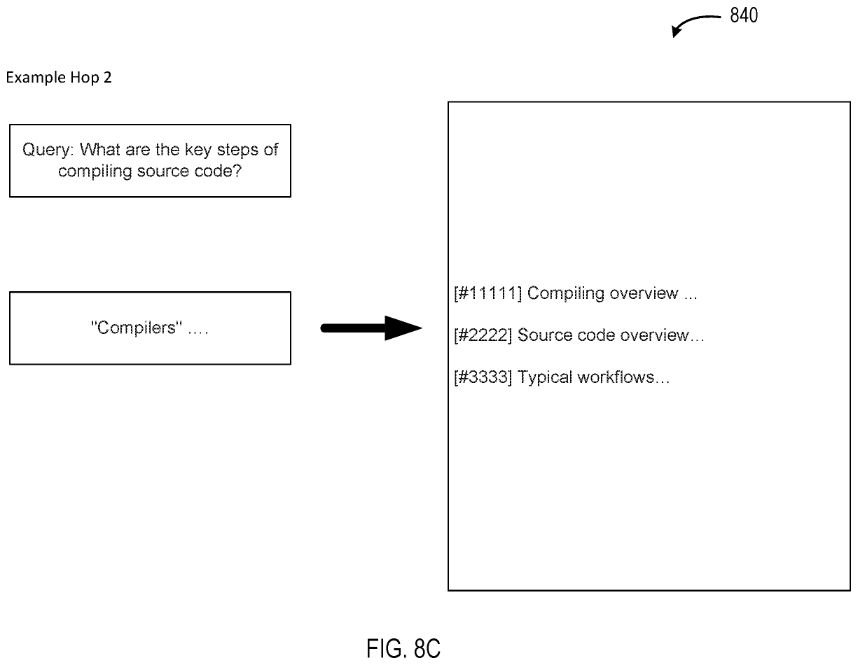

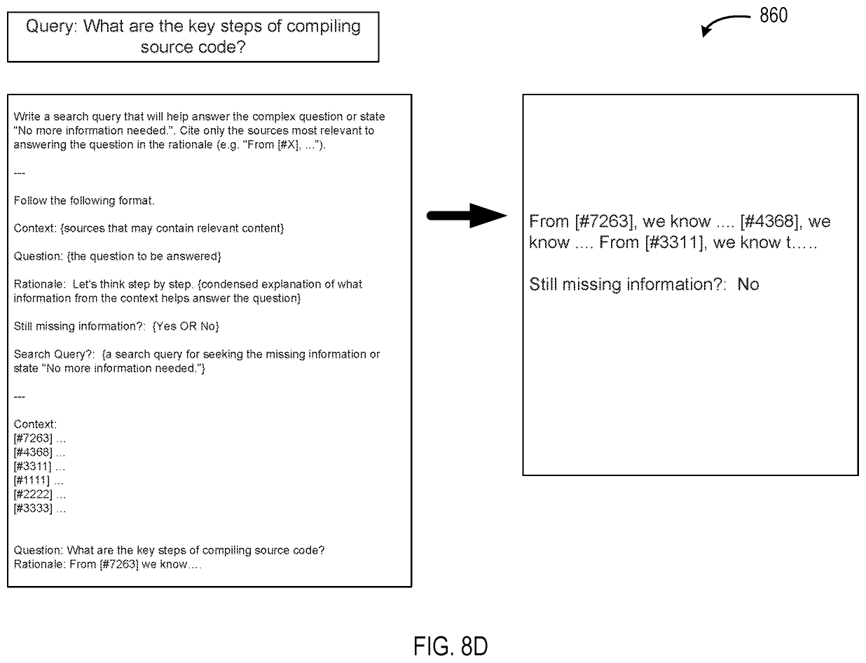

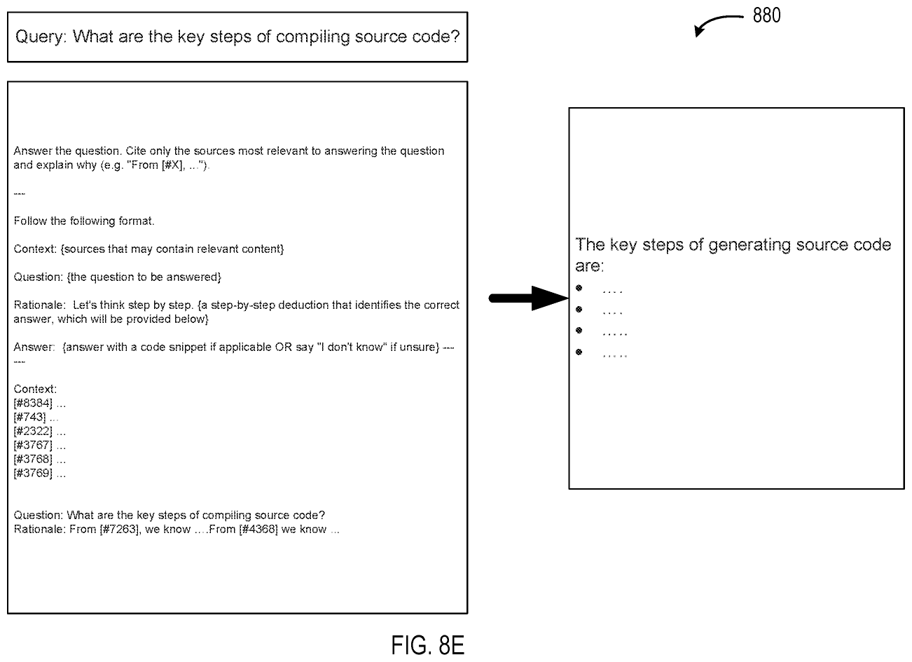

The prompt generation module 210 can function to generate large language model prompts (or, simply, prompts) and prompt templates. For example, the prompt generation module 210 may generate a prompt template for processing an initial input, a prompt template for processing iterative inputs (i.e., inputs received during the iteration process after the initial input is processed), and another prompt template for the output result phase (i.e., when the context-based comprehension module 208 has determined that it has enough information and/or a stopping condition is satisfied). The prompt generation module 210 may modify the appropriate prompt template depending on a phase of the iterative process. For example, prompt templates can be modified to generate prompts that include rationales and contexts, which can inform subsequent iterations. Example prompts and an example prompt flow from the initial input phase to the answer phase is shown in FIGS. 8A-8E.

The supervisor module 212 can function to execute and/or otherwise process various supervisory functions. In some implementations, the supervisor module 212 may enforce conditions (e.g., stopping conditions, resource allocation, prioritization, and/or the like). For example, a stopping condition may indicate a maximum number of iterations (or, hops) that can be performed before the iterative process terminates. The stopping condition, and/or other features managed by the supervisor module 212, may be included in the prompts and/or in the large language models of the context-based comprehension module 208. In some embodiments, the stopping conditions can ensure that the iterative context-based generative artificial intelligence system 102 will not get stuck in an endless loop. This feature can also allow the iterative context-based generative artificial intelligence system 102 the flexibility of having a different number of iterations for different inputs (e.g., as opposed to having a fixed number of hops). In another example, the supervisor module 212 can perform resource allocation such as virtualization or load balancing based on computing conditions. In some implementations, the supervisor module 212 includes models that can convert (or, transform) an image, database table, and/or other non-text input, into text format (e.g., natural language).

The supervisor module 212 may also cooperate and/or control some or all of the other components of the iterative context-based generative artificial intelligence system 102. For example, the supervisor module 212 may cooperate and/or control the model tuning module 216 to train (or retrain) one or more models of the iterative context-based generative artificial intelligence system 102 based on user feedback using reinforcement learning and/or other machine learning techniques.

The model generation module 214 can function to obtain, generate, and/or modify some or all of the different types of models described herein (e.g., multimodal machine learning models, large language models, data models). In some implementations, the model generation module 214 can use a variety of machine learning techniques or algorithms to generate models. As used herein, artificial intelligence and/or machine learning can include Bayesian algorithms and/or models, deep learning algorithms and/or models (e.g., artificial neural networks, convolutional neural networks), gap analysis algorithms and/or models, supervised learning techniques and/or models, unsupervised learning algorithms and/or models, semi-supervised learning techniques and/or models random forest algorithms and/or models, similarity learning and/or distance algorithms, generative artificial intelligence algorithms and models, clustering algorithms and/or models, transformer-based algorithms and/or models, neural network transformer-based machine learning algorithms and/or models, reinforcement learning algorithms and/or models, and/or the like. The algorithms may be used to generate the corresponding models. For example, the algorithms may be executed on datasets (e.g., domain-specific data sets, enterprise datasets) to generate and/or output the corresponding models.

The model generation module 214 can function to deploy some or all of the different types of models described herein. In some implementations, the model generation module 214 can deploy models before or after a deployment of a generative artificial intelligence system. For example, the model generation module 214 may cooperate with the model swapping module 218 to swap or otherwise change large language models of a deployed system.

The model tuning module 216 can function to enable tuning and learning by the modules (e.g., the context-based comprehension module 208) and/or the models (e.g., machine learning models, large language models) described herein. For example, the model tuning module 216 may tune the context-based comprehension module 208 (and/or models thereof) based on tracking user interactions within systems, capturing explicit feedback (e.g., through a training user interface), implicit feedback, and/or the like. In some example implementations, the model tuning module 216 can use reinforcement learning to accelerate knowledge base bootstrapping. Reinforcement learning can be used for explicit bootstrapping of various systems (e.g., the iterative context-based generative artificial intelligence system 102) with instrumentation of time spent, results clicked on, and/or the like. Example aspects of the model tuning module 216 include an innovative learning framework that can bootstrap models for different enterprise environments. Example aspects of the model tuning module 216 can include an innovative learning framework that can bootstrap models for different enterprise environments.

Reinforcement learning is a machine learning training method based on rewarding desired behaviors and/or punishing undesired ones. In general, a reinforcement learning agent is able to perceive and interpret its environment, take actions and learn through trial and error. Reinforcement Learning uses algorithms and models to determine optimal behavior in an environment to obtain maximum reward. This optimal behavior is learned through interactions with the environment and observations of how it responds. In the absence of a supervisor, the learner must independently discover the sequence of actions that maximize the reward. This discovery process is akin to a trial-and-error search. The quality of actions is measured by not just the immediate reward they return, but also the delayed reward they might fetch. As it can learn the actions that result in eventual success in an unseen environment without the help of a supervisor, reinforcement learning is a very powerful algorithm. ColBERT is an example retriever model, enabling scalable BERT-based search over large text collections (e.g., in tens of milliseconds). ColBERT uses a late interaction architecture that independently encodes a query and a document using BERT and then employs a “cheap” yet powerful interaction step that models their fine-grained similarity. Beyond reducing the cost of re-ranking documents retrieved by a traditional model, ColBERT's pruning-friendly interaction mechanism enables leveraging vector-similarity indexes for end-to-end retrieval directly from a large document collection.

The model tuning module 216 can retrain models (e.g., transformer-based natural language machine learning models) periodically, on-demand, and/or in real-time. In some example implementations, corresponding candidate model (e.g., candidate transformer-based natural language machine learning models) can be trained based on the user selections and the model tuning module 216 can replace some or all of the models with one or more candidate models that have been trained on the received user selections.

The model swapping module 218 can function to change models of the iterative context-based generative artificial intelligence system 102 at or during run-time in addition to before or after run-time. For example, the retriever module 206 and/or the context-based comprehension module 208 may use particular sets of machine learning models for one domain and other models for different domains. The model swapping module 218 may select and use the appropriate models for a given domain. This may even occur during the iteration process. For example, as new queries are generated by the context-based comprehension module 208, the domain may change which may trigger the model swapping module 218 to select and deploy a different model that is appropriate for that domain.

The parallelization module 220 can function to control the parallelization of the various systems, modules, agents, models, generators, components, and processes described herein. For example, the parallelization module 220 may spawn parallel executions of different modules (e.g., retriever module 206, context-based comprehension module 208) and/or models (e.g., retriever models, large language models). Like the other modules described herein, the parallelization module 220 may be controlled by the supervisor module 212.

The communication module 222 can function to send requests, transmit and receive communications, and/or otherwise provide communication with one or more of the systems, modules, engines, layers, devices, datastores, and/or other components described herein. In a specific implementation, the communication module 222 may function to encrypt and decrypt communications. The communication module 222 may function to send requests to and receive data from one or more systems through a network or a portion of a network (e.g., communication network 108). In a specific implementation, the communication module 222 may send requests and receive data through a connection, all or a portion of which can be a wireless connection. The communication module 222 may request and receive messages, and/or other communications from associated systems, modules, layers, and/or the like. Communications may be stored in the iterative context-based generative artificial intelligence system datastore 270.

The model registry datastore 240 can function to store different models and/or model configurations. For example, the model registry may store different configurations of various large language models (e.g., which can be deployed or swapped in an iterative context-based generative artificial intelligence system 102).

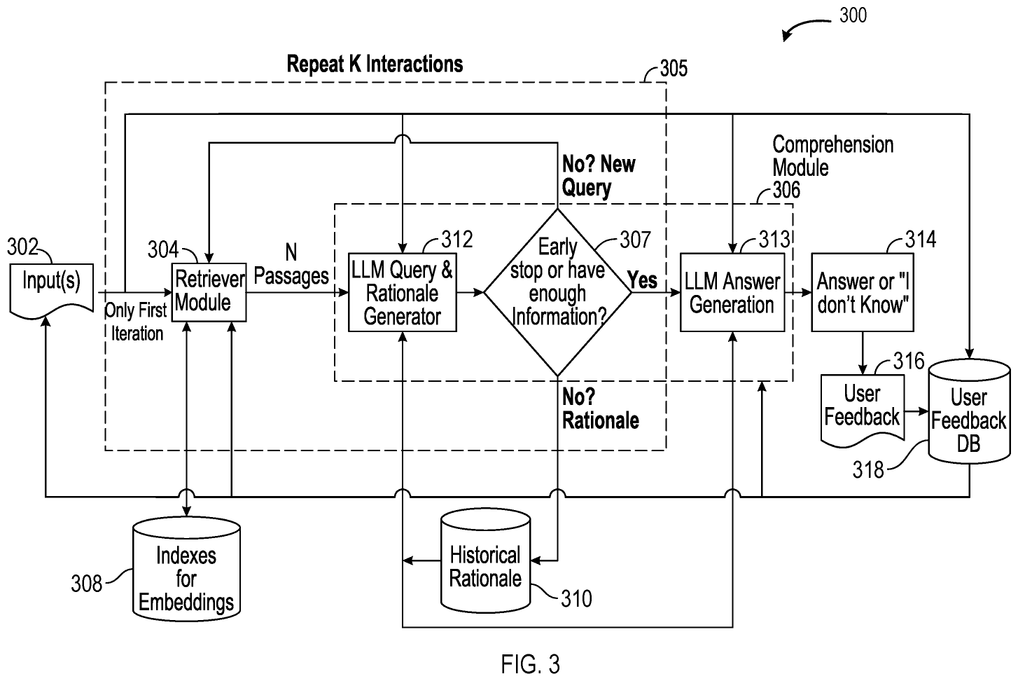

FIG. 3 depicts a diagram 300 of an example architecture and an example method of operation of an iterative context-based generative artificial intelligence system (e.g., iterative context-based generative artificial intelligence system 102) according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In the example of FIG. 3, the components of an iterative context-based generative artificial intelligence system 102 include one or more retriever modules 304 and one or more context-based comprehension modules 306. For example, the retriever module 304 can include one or more machine learning models (e.g., neural network transformer-based machine learning models), and the context-based comprehension module can include one or more context-aware large language models. These modules, and the iterative interactions (e.g., communication) between these modules, allow the iterative context-based generative artificial intelligence system to achieve the technical features and technical benefits discussed herein.

In the example of FIG. 3, an iterative context-based generative artificial intelligence system can receive an initial input 302 (e.g., a complex input) from a user and/or system. The iterative context-based generative artificial intelligence system can provide that input to the retriever module 304 which can then reach out and “retrieve” information from various data sources (e.g., embeddings datastore 308, and/or other datastores, databases, artificial intelligence applications, and/or the like). The retriever module 304 can provide the retrieved information to a query and rationale generator 312 of a context-based comprehension module 306 to generate an initial prompt and/or query for processing by one or more large language models of the context-based comprehension module 306.

The context-based comprehension module 306 can process the initial prompt and determine whether it has enough information to satisfy validation criteria of the large language models of the context-based comprehension module 306, and thereby satisfy the initial input. If it has enough information to satisfy the initial input, the context-based comprehension module 306 can then provide the result 314 to a recipient, such as a user or system that provided the initial input 302. However, if the context-based comprehension module 306 determines that it does not have enough information to satisfy the validation criteria, it can further synthesize information via an iterative process which provides the core benefit of the system.

The validation criteria can include large language model rules, large language model conditions, context-based comprehension module rules, context-based comprehension module conditions, and/or a context quality threshold. For example, the rules, conditions and/or thresholds may include one or more stopping conditions. Each stopping condition may be associated with a different type of input. For example, different types of input can include complex inputs, non-complex inputs, length of input, whether the input includes any Boolean operators (and if so, how many). Input type can also include natural language input type, instruction set input type, user input type, and/or system input type. In some embodiments, the rules, conditions and/or thresholds can be user defined and/or automatically defined. For example, the context-based comprehension module 306 may define the rules, conditions and/or thresholds based on pre-loaded configurations, model training, and/or model tuning (e.g., based on reinforcement learning).

The context-based comprehension module 306 can provide the output of the large language model to the retriever module 304 which can retrieve additional information based on the received output of the large language model. The retriever module 304 can provide the additional information to the query and rationale generator 312 which can generate a rationale and/or context based on that output, as well as a new query and/or prompt based on the rationale and/or context. For example, the new prompt and/or query may include the rational and/or context. The query and rationale generator 312 can then provide the new query and/or prompt to the large language model of the context-based comprehension module 306, which can then determine whether the validation criteria are satisfied. This process can be iteratively repeated until the validation criteria is satisfied and/or a stopping condition is satisfied.

There can be many reasons that the context-based comprehension module 306 may need additional information. For example, traditional generative artificial intelligence systems only use a single pass process which only addresses a portion of a complex input. The iterative context-based generative artificial intelligence system addresses this problem by triggering subsequent iterations to solve the remaining portions of the complex input, as well as including context to further refine the process.

For example, if the context-based comprehension module determines that it needs additional information to satisfy the initial input, it generates context-specific data (or, simply, “context”) that will inform future iterations of the process and help the system more efficiently and accurately satisfy the initial input. The context is based on the rationale used by the context-based comprehension module 306 when it is processing queries (or other inputs). For example, the context-based comprehension module 306 may receive segments of information retrieved by the retriever module 304 from the index of embedding 308. The segments may be passages of a data record, for example, and the segments may be associated with embeddings that facilitate processing by the context-based comprehension module. For example, the embeddings may comprise vector values associated with a corresponding data record and/or segment (e.g., the embedding value may be inserted in a header of a corresponding data record and/or segment). The context-based comprehension module 306 can process the information and generate a rationale for why it produced the result that it did. That rationale can be stored in the historical rational datastore 310 by the iterative context-based generative artificial intelligence system and provide the foundation for the context in the subsequent iteration.

Subsequent iterations can include the context-based comprehension module 306 (or the query and rationale generator 312 more specifically) generating a new query, request, or other output that is then passed back to the retriever module 304. The retriever module 304 can process that new query and retrieve additional information. The query and rationale generator 312 can then generate a new prompt and/or query based on the additional information and the context. The context-based comprehension module 306 can process the new prompt and/or query and again determine if it needs additional information (sec, e.g., step 307). If it needs additional information, the iterative context-based generative artificial intelligence system can repeat (e.g., iterate) this process until the context-based comprehension module 306 can satisfy validation criteria based on the initial input, at which point the context-based comprehension module 306 can generate the output result (e.g., “answer” or “I don't know”). The output result may be determined by a large language model (see, e.g., step 313). The large language model used for generating answers may be a large language model fine-tuned for answer generation.

In some embodiments, generating the answer “I don't know” if no relevant passages have been generated, retrieved, and/or extracted (e.g., by applying a rule of the comprehension module 306) and/or not enough relevant passages have been generated, retrieved, and/or extracted, the context-based comprehension module 306 can prevent hallucination and increase the performance on the “I don't know” queries while saving a call to the models (e.g., large language models).

In some embodiments, whether there is enough information may be determined and/or correlated based on the number of passages that are retrieved but no relevant information was extracted (e.g., by the context-based comprehension module 306). For example, a threshold number or percentage of the retrieved passage that had relevant information extracted may need to be satisfied (e.g., a particular number or percentage of the retrieved passages) for the enterprise comprehension module to determine that it has enough information to answer the query. In another example, a threshold number or percentage of the retrieved passages that had no relevant information extracted (e.g., 4 passages or 80% of the retrieved passages) may cause the enterprise comprehension module to determine that it does not have enough information to answer the query.

The iterative context-based generative artificial intelligence system may also implement supervisory functions, such as a stopping condition which caps the number of iterations that can be performed before the context-based comprehension module 306 will either provide an output result or indicate that an output result cannot be found. The user may also provide feedback 316 which can be stored in a feedback datastore 318. The iterative context-based generative artificial intelligence system can, in some embodiments, use the feedback to improve the accuracy and/or reliability of the system.

Different retriever models can be used or combined between iterative steps. The iterative processing can combine different large language models and/or retriever models to synthesize information. For example, an initial retriever model can retrieve information for a first large language model to synthesize. The output of the first large language model can be used with a different retriever model to retrieve additional information that can be passed to the first large language model or a different large language model to synthesize. Combining different large language models and retriever models iteratively can develop context-specific and/or domain-specific answers and also improve training of the large language model and retriever models.

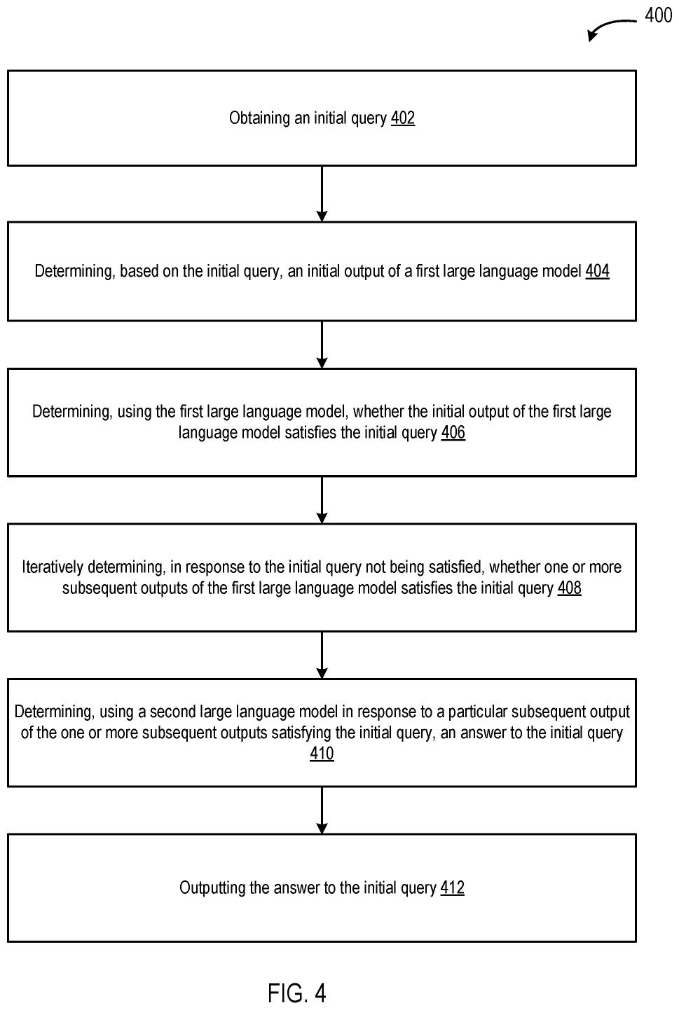

FIG. 4 depicts a flowchart 400 of an example method of iterative context-based generative artificial intelligence according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 402, an iterative context-based generative artificial intelligence system (e.g., iterative context-based generative artificial intelligence system 102) obtains an initial query (e.g., complex input 302). In some embodiments, an interface module (e.g., interface module 204) obtains the query. In some embodiments, the initial query can be natural language query, an instruction set (e.g., an executable instruction set, a user query, a system query, and/or other input.

In step 404, the iterative context-based generative artificial intelligence system determines, based on the initial query, an initial output of a first large language model. In some embodiments, a first large language model of a context-based comprehension module (e.g., context-based comprehension module 208 and/or 306) determines the initial output. For example, the initial query may comprise an input for a retriever module (e.g., retriever module 206 or 304), and/or the input for the large language model may be based on the initial query (e.g., a query transformed from the initial query).

In step 406, the iterative context-based generative artificial intelligence system determines, using the first large language model, whether the initial output of the first large language model satisfies the initial query. For example, the first large language model may take the initial output as an input, and then determine whether the initial output satisfies the initial query (e.g., based on validation criteria of the large language model).

In step 408, the iterative context-based generative artificial intelligence system iteratively determines, in response to the initial query not being satisfied, whether one or more subsequent outputs of the first large language model satisfies the initial query. In some embodiments, the context-based comprehension module and one or more retriever modules (e.g., retriever module 206) iteratively determines whether the one or more subsequent outputs of the first large language model satisfies the initial query.

In step 410, the iterative context-based generative artificial intelligence system determines, using a second large language model (e.g., answer generation module 322) in response to a particular subsequent output of the one or more subsequent outputs satisfying the initial query, an answer to the initial query. In some embodiments, the context-based comprehension module, or the answer generation module of the context-based comprehension module, determines the answer (e.g., answer 314) to initial query. In some embodiments, the second large language model is different from the first large language model. In some embodiments, the second large language model is the same large language model as the first large language model.

In step 412, the iterative context-based generative artificial intelligence system outputs the answer to the initial query. In some embodiments, the second large language model and/or the interface module output the answer. In some embodiments, the iterative context-based generative artificial intelligence system can pre-process the initial query to transform the input, and the above steps can be performed using the transformed input instead of the initial query. For example, a supervisor module (e.g., supervisor module 212) can separate the initial query into a plurality of different sub-queries that can each be processed by a different retriever module.

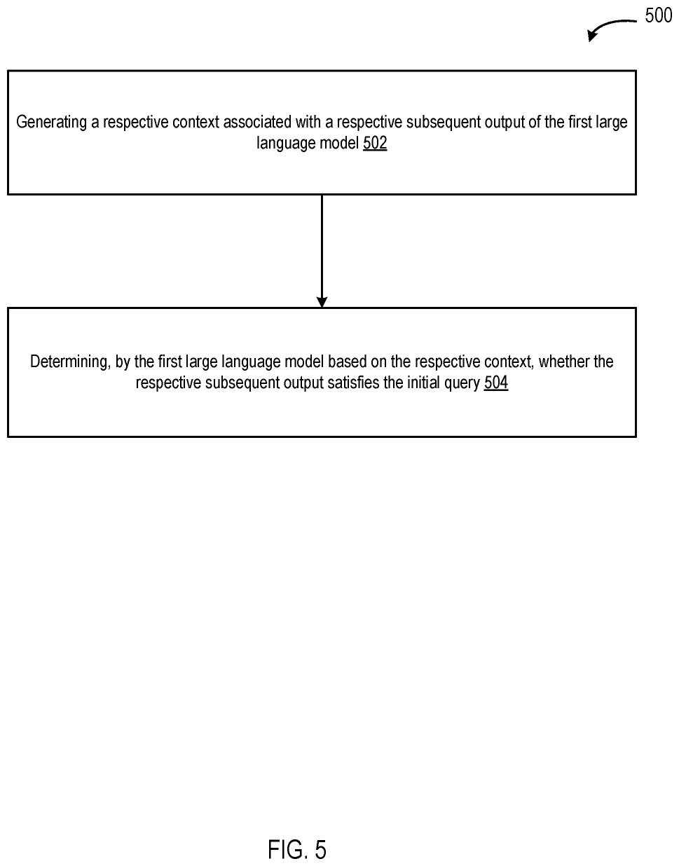

FIG. 5 depicts a flowchart 500 of an example method of an iteration of an iterative process for determining whether a large language model output satisfies an initial input according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 502, an iterative context-based generative artificial intelligence system (e.g., iterative context-based generative artificial intelligence system 102) generates a respective context associated with a respective subsequent output of the first large language model. For example, the respective context may comprise a concatenation of different portions of the data records used to determine whether a large language model output satisfies the initial query. In some embodiments, a query and rationale generator (e.g., query and rationale generator 312) and/or context-based comprehension module (e.g., context-based comprehension module 208 or 306) generates the respective context.

In step 504, the iterative context-based generative artificial intelligence system determines, by the first large language model based on the respective context, whether the respective subsequent output satisfies the initial query. In some embodiments, the context-based comprehension module determines whether the respective subsequent output satisfies the initial query. In some embodiments, the method 500 may terminate prior to an answer being determined. For example, a stopping condition may indicate a maximum number of iterative determinations (e.g., loops) that can be performed, and the iterative context-based generative artificial intelligence system can terminate the iterative process when the stopping condition is satisfied (e.g., the maximum number of iterations is reached). In some embodiments, the stopping condition comprises an attribute of the first large language model and/or the context-based comprehension module. In some embodiments, the iterative context-based generative artificial intelligence system generates a subsequent query based on the respective subsequent output of the first large language model and the respective context. The first large language model can determine whether the respective subsequent output of the first large language model satisfies the initial query based on the subsequent query. Thus, for example, each iteration (or loop) of iterative determinations (or, iterative process) can iteratively generate and process subsequent queries that can be processed by the large language model to determine with a subsequent satisfies an initial input.

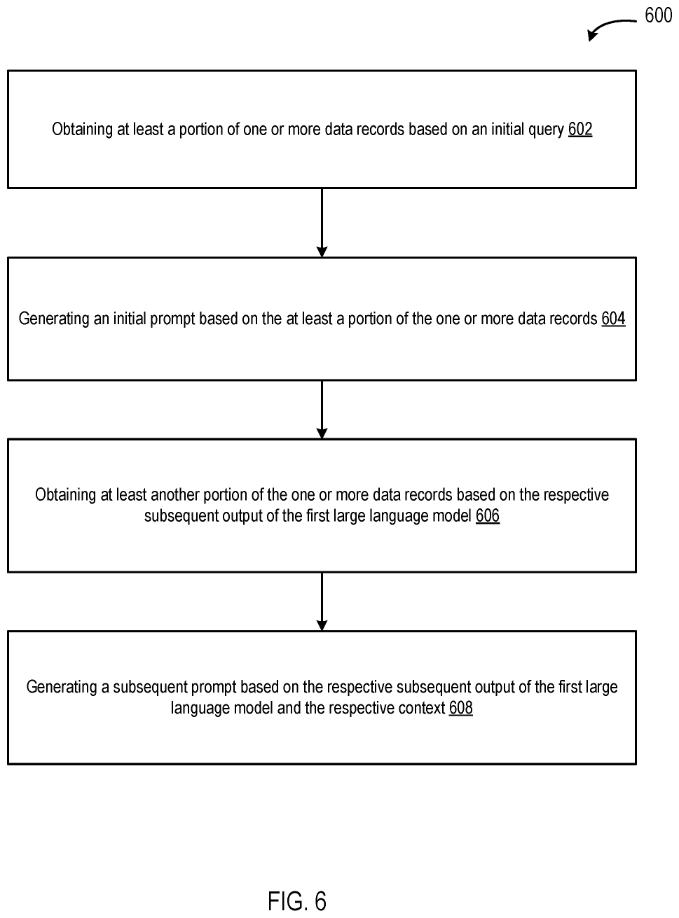

FIG. 6 depicts a flowchart 600 of an example method of generating and using prompts in an iterative context-based generative artificial intelligence process according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 602, an iterative context-based generative artificial intelligence system (e.g., iterative context-based generative artificial intelligence system 102) obtains at least a portion (e.g., one or more segments) of one or more data records based on an initial query (e.g., complex input 302). For example, the initial query may comprise a complex input. In some embodiments, a retriever module (e.g., retriever module 206 or 304) obtains the portions of data records. In some embodiments, a retriever model of the retriever module obtains the portions of data records. In step 604, the iterative context-based generative artificial intelligence system generates an initial prompt based on the at least a portion of the one or more data records. Example prompts are shown in FIGS. 8A-8E. In some embodiments, a prompt generation module (e.g., prompt generation module 210 generates the initial prompt.

In step 606, the iterative context-based generative artificial intelligence system obtains at least another portion (e.g., one or more other segments) of the one or more data records based on the respective subsequent output of the first large language model. In some embodiments, the retriever module and/or retriever model obtain the other portion of data records. In some embodiments, the retriever module obtains the portions of the data records, and the retriever module can provide the portions of the data records to the first large language model. In various embodiments, the retriever module comprises one or more tools (e.g., a code generation tool, document retrieval tool, image retrieval tool, and/or the like), machine learning models and/or large language models. For example, each portion of the data records may be associated with an embedding value (e.g., a vector value from the embeddings datastore 260), and the portions of the data records may be obtained based on the embedding value and an embedding index (e.g., the embeddings datastore 260). For example, the retriever module 304 may use a similarity machine learning model to locate similar data records based on a similarity of the embedding values and/or content of the data records. In step 608, the iterative context-based generative artificial intelligence system generates a subsequent prompt based on the respective subsequent output of the first large language model and the respective context. In some embodiments, the prompt generation module generates the subsequent prompts.

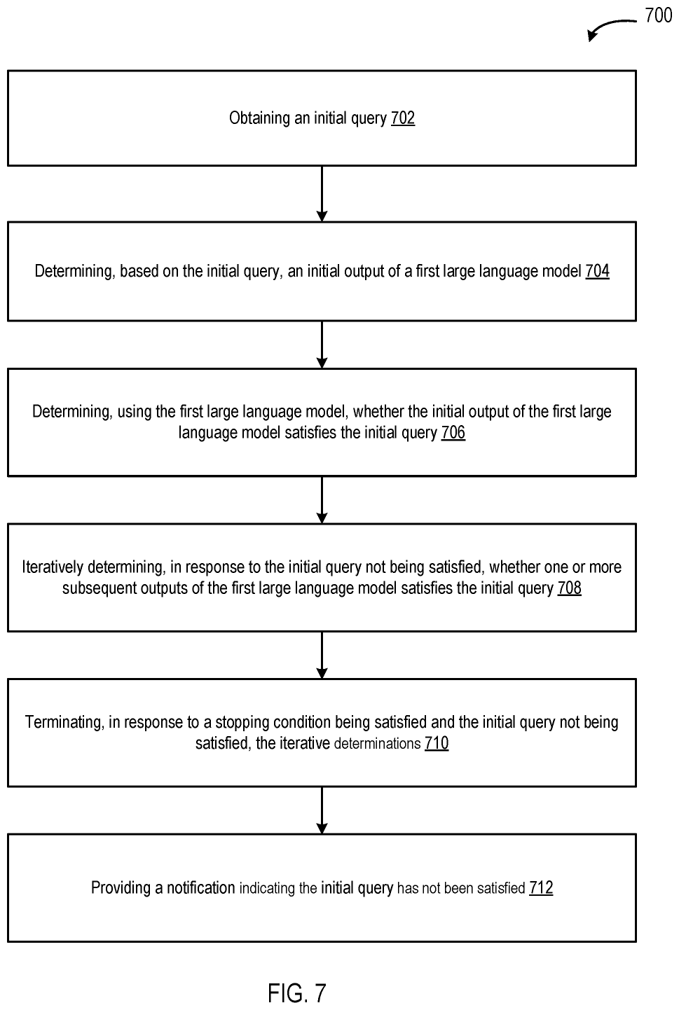

FIG. 7 depicts a flowchart 700 of an example method of iterative context-based generative artificial intelligence using stopping conditions according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 702, an iterative context-based generative artificial intelligence system (e.g., iterative context-based generative artificial intelligence system 102) obtains an initial query (e.g., complex input 302). In some embodiments, an interface module (e.g., interface module 204) obtains the initial query. In step 704, the iterative context-based generative artificial intelligence system determines, based on the initial query, an initial output (e.g., a natural language output) of a first large language model. In some embodiments a context-based comprehension module (e.g., context-based comprehension module 208 and/or 306) determines the initial output.

In step 706, the iterative context-based generative artificial intelligence system determines, using the first large language model, whether the initial output of the first large language model satisfies the initial query. In some embodiments, the context-based comprehension module determines whether the initial output of the first large language model satisfies the initial query. In step 708, the iterative context-based generative artificial intelligence system iteratively determines, in response to the initial query not being satisfied, whether one or more subsequent outputs of the first large language model satisfies the initial query. In some embodiments, the context-based comprehension module iteratively determines whether a subsequent output of the first large language model satisfies the initial query.

In step 710, the iterative context-based generative artificial intelligence system terminates, in response to a stopping condition being satisfied and the initial query not being satisfied, the iterative determinations. In some embodiments, the context-based comprehension module terminates the iterative determinations based on the stopping condition. For example, the stopping condition may comprise an attribute the first large language model and/or the context-based comprehension module. In step 712, the iterative context-based generative artificial intelligence system provides a notification (e.g., notification 314) indicating the initial query has not been satisfied. In some embodiments, the context-based comprehension module generates and/or provides the notification. In some embodiments, a communication module (e.g., communication module 222) provides (e.g., transmits) the notification to one or more recipients (e.g., one or more users or systems that provided the initial query).

FIGS. 8A-E depict diagrams 800, 820, 840, 860, and 880 of example prompts for iterative context-based generative artificial intelligence according to some embodiments. For example, the prompt depicted in diagram 800 may correspond to an initial phase of an iterative process of an iterative context-based generative artificial intelligence system (e.g., iterative context-based generative artificial intelligence system 102); the prompt depicted in diagrams 820-860 may correspond to interim phases of the iterative process of the iterative context-based generative artificial intelligence system; and the prompt depicted in diagram 880 may correspond to an answer phase of the iterative process of the iterative context-based generative artificial intelligence system.

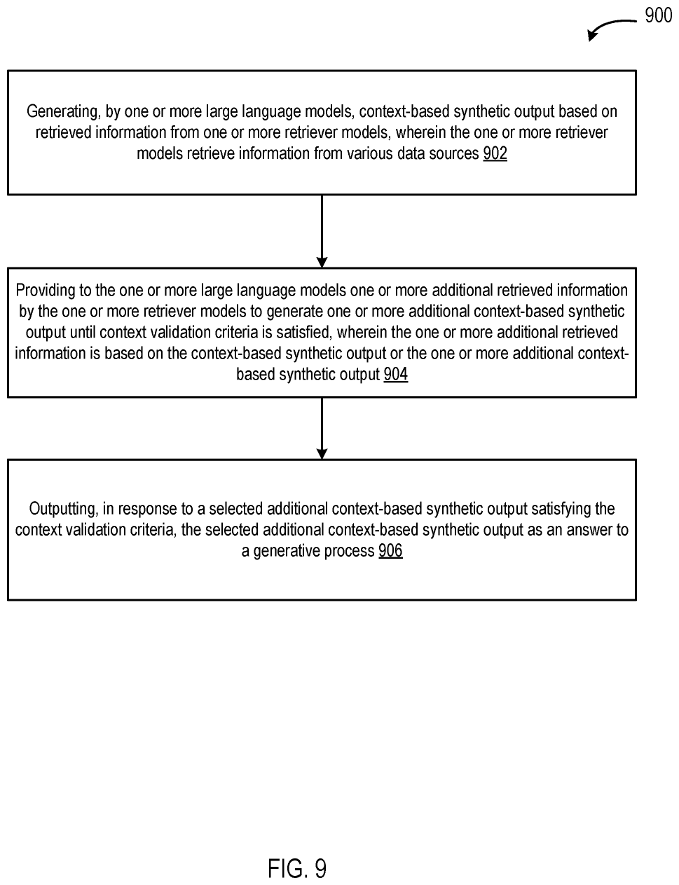

FIG. 9 depicts a flowchart 900 of an example method of iterative context-based generative artificial intelligence including generating and using context-based synthetic output according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 902, an iterative context-based generative artificial intelligence system (e.g., iterative context-based generative artificial intelligence system 102) generates, by one or more large language models, context-based synthetic output based on retrieved information from one or more retriever models (e.g., of one or more retriever modules 206 and/or 304). The one or more retriever models may retrieve information from various data sources (e.g., enterprise data sources and/or an embeddings datastore 260). In some embodiments, the one or more large language models comprise at least a portion of a context-based comprehension module (e.g., context-based comprehension module 208 and/or 306).

In step 904, the iterative context-based generative artificial intelligence system provides to the one or more large language models one or more additional retrieved information by the one or more retriever models to generate one or more additional context-based synthetic output until context validation criteria or criterion is satisfied. The one or more additional retrieved information may be based on the context-based synthetic output and/or the one or more additional context-based synthetic output. It will be appreciated that in various embodiments, reference to a singular term (e.g., criterion) may also include the plural variant (e.g., criteria) instead of, or in addition to, the singular term. Similarly, reference to a plural term (e.g., criteria) may also include the singular variant (e.g., criterion) instead of, or in addition to, the plural term. In some embodiments, the context-based synthetic output may be generated based on retrieved information and natural language processing input. In some embodiments, providing one or more additional retrieved information is repeated (or iterated) by different retriever models of the one or more retriever models and different large language models of the large language models.

In step 906, the iterative context-based generative artificial intelligence system outputs, in response to a selected additional context-based synthetic output satisfying the context validation criteria or criterion, the selected additional context-based synthetic output as an answer to a generative process. In some embodiments, the context-based synthetic output is a natural language output from a loop (or iteration) of an iterative generative process that includes a concatenation of data record segments and fails to satisfy the context validation criteria based on a termination condition, an initial input, and/or one or more quality rules of the one or more large language models. In some embodiments, the additional context-based synthetic output can be a subsequent natural language output from a subsequent loop of the iterative generative process that includes a concatenation of data record segments and satisfies the context validation criteria based on a termination condition (e.g., stopping condition), an initial input, and one or more quality rules of the one or more large language models. In some embodiments, the context validation criteria includes large language model rules, large language model conditions, context-based comprehension module rules, context-based comprehension module conditions, and/or a context quality threshold. In some embodiments, a first large language model of the one or more large language models generates the context-based synthetic output, and a different large language model of the one or more large language models generates the one or more additional context-based synthetic outputs. In some embodiments, the selected additional context-based synthetic output that satisfies the context validation criteria is different from the context-based synthetic output.

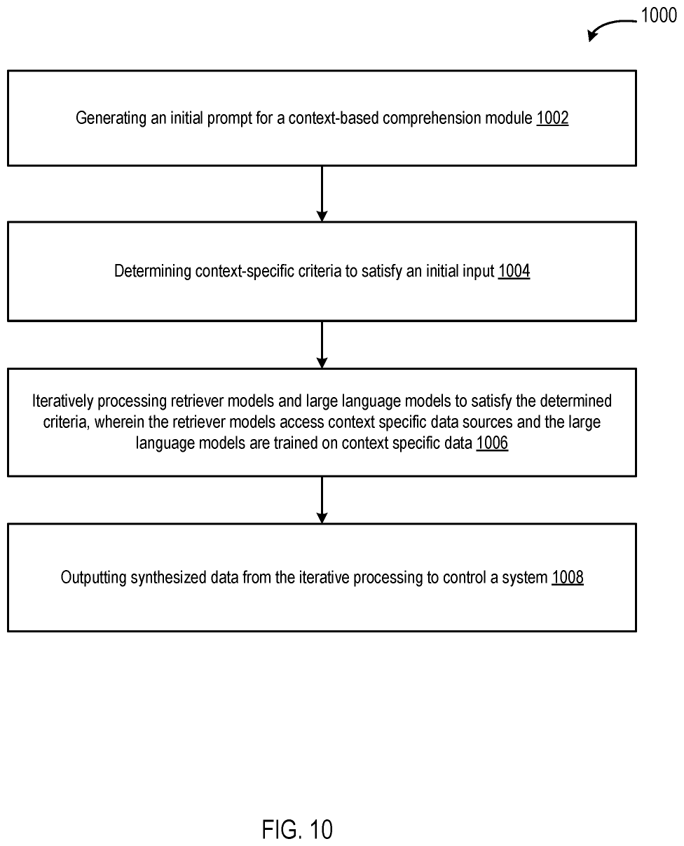

FIG. 10 depicts a flowchart 1000 of an example method of iterative context-based generative artificial intelligence including generating and using prompts and synthesized data according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 1002, an iterative context-based generative artificial intelligence system (e.g., iterative context-based generative artificial intelligence system 102) generates an initial prompt for a context-based comprehension module (e.g., context-based comprehension module 208 and/or 306). For example, the initial prompt may be generated based on an initial query (e.g., complex input 302). In some embodiments, a prompt generation module (e.g., prompt generation module 210) generates the initial prompt.

In step 1004, the iterative context-based generative artificial intelligence system determines context-specific criteria to satisfy an initial input (e.g., complex input 302). For example, the context-specific criteria may be based on a domain associated with an initial query and/or a type of input. The context-specific criteria may include stopping conditions, quality thresholds, and the like. For example, quality thresholds may indicate a threshold value that must be met in order for an answer to be generated. The quality thresholds may differ based on the user (or user role) or system providing the initial input, the associated domains, the type of input, and the like. For example, quality thresholds may be higher for queries in the aerospace domain as opposed to defense domain. In some embodiments, satisfying the determined criteria includes determining if enough information meets a context threshold. For example, the context-based comprehension module may determine whether the information it has processed meets a context threshold (e.g., as defined by the large language model).

In step 1006, the iterative context-based generative artificial intelligence system iteratively processes retriever models (e.g., of the retriever module 206 and/or 304) and large language models (e.g., of the context-based comprehension module) to satisfy the determined criteria. The retriever models may access context-specific data sources and the large language models may be trained on the context-specific data. In some embodiments, the iterative processing includes generating one or more interim prompt templates. The one or more interim prompt templates can include rationales and contexts which can inform subsequent iterations. The iterative processing can also include determining one of the subsequent iterations satisfies a condition, and/or generating another prompt template for an answer phase based on the determination.

In step 1008, the iterative context-based generative artificial intelligence system outputs synthesized data from the iterative processing to control one or more systems (e.g., an enterprise system 104 and/or external systems 106). In some embodiments, the context-based comprehension module outputs the synthesized data.

The system may leverage characteristics of a model driven architecture, which represent system objects (e.g., components, functionality, data, etc.) using rich and descriptive metadata, to dynamically generate queries for conducting searches across a wide range of data domains (e.g., documents, tabular data, insights derived from AI applications, web content, or other data sources). Furthermore, the query modules of embodiments may be particularly well suited to searches involving type systems, which expose objects through metadata. Accordingly, the query modules disclosed herein represent an improvement in the field of query modules and provide a mechanism for rapidly deploying search functionality across a wide variety of data domains relative to existing query modules, which are typically limited with respect to their searchable data domains (e.g., web query modules are limited to web content, file system query modules are limited to searches of file system, and so on). The type system provides data accessibility, compatibility and operability with disparate systems and data. Specifically, the type system solves data operability across diversity of programming languages, inconsistent data structures, and incompatible software application programming interfaces. Type system provides data abstraction that defines extensible type models that enables new properties, relationships and functions to be added dynamically without requiring costly development cycles. The type system can be used as a domain-specific language (DSL) within a platform used by developers, applications, or UIs to access data. The type system provides interact ability with data to perform processing, predictions, or analytics based on one or more type or function definitions within the type system.

Type definitions can be a canonical type declared in metadata using syntax similar to that used by types persisted in the relational or NoSQL data store. A canonical model in the type system is a model that is application agnostic (i.e., application independent), enabling all applications to communicate with each other in a common format. Unlike a standard type, canonical types are comprised of two parts, the canonical type definition and one or more transformation types. The canonical type definition defines the interface used for integration and the transformation type is responsible for transforming the canonical type to a corresponding type. Using the transformation types, the integration layer may transform a canonical type to the appropriate type.

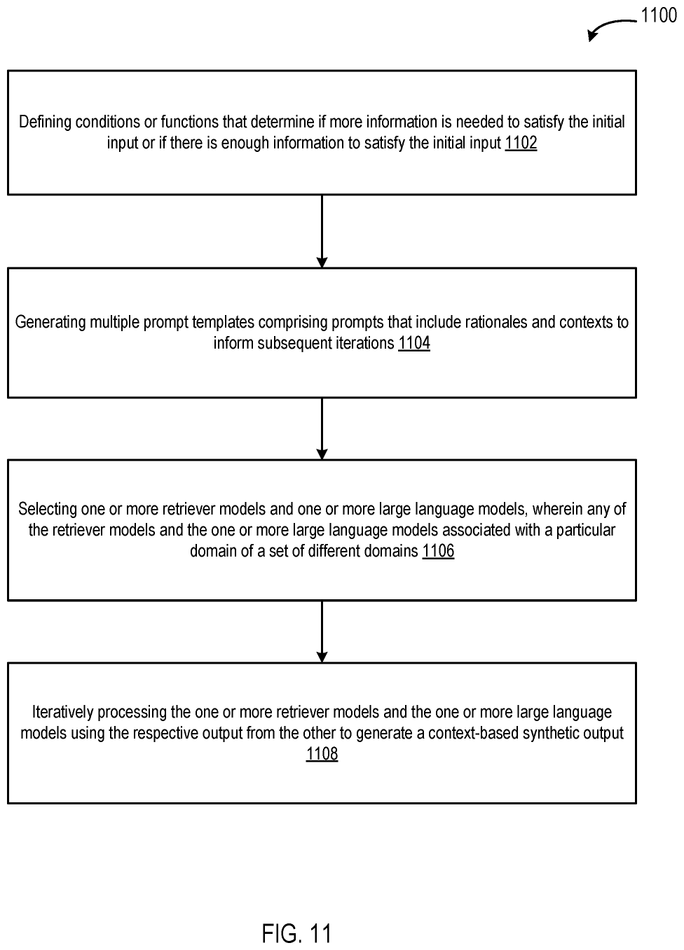

FIG. 11 depicts a flowchart 1100 of an example method of iterative context-based generative artificial intelligence including prompt templates according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 1102, an iterative context-based generative artificial intelligence system (e.g., iterative context-based generative artificial intelligence system 102) defines conditions and/or functions that determine if more information is needed to satisfy the initial input or if there is enough information to satisfy the initial input. In some embodiments, a context-based comprehension module (e.g., context-based comprehension module 208 and/or 306) define the conditions and/or functions automatically (e.g., without requiring user input) and/or based on user input. In step 1104, the iterative context-based generative artificial intelligence system generates multiple prompt templates comprising prompts that include rationales and contexts to inform subsequent iterations. In some embodiments, a prompt generation module (e.g., prompt generation module 210) generates the multiple prompt templates and the rationales and context may be obtained by the prompt generation module from a rational and context datastore (e.g., rationale context datastore 230).

In step 1106, the iterative context-based generative artificial intelligence system selects one or more retriever models (e.g., of one or more retriever modules 206 and/or 304) and one or more large language models (e.g., of the context-based comprehension module). The retriever models and/or the one or more large language models may be associated with a particular domain (e.g., aerospace domain) of a set of different domains (e.g., aerospace domain, defense domain, and/or other domains). In some embodiments, a supervisor module (e.g., supervisor module 212) and/or the retriever module(s) select the one or more retriever models. In some embodiments, the supervisor module can also execute and/or otherwise process various supervisory functions (e.g., stopping conditions, terminating iterative processes). In step 1108, the iterative context-based generative artificial intelligence system iteratively processes the one or more retriever models and the one or more large language models using the respective output from the other to generate a context-based synthetic output. In some embodiments, the iterative processing includes an initial phase, an interim phase, a determination phase, an answer phase, an instruction phase, and a control phase (e.g., as discussed elsewhere herein).

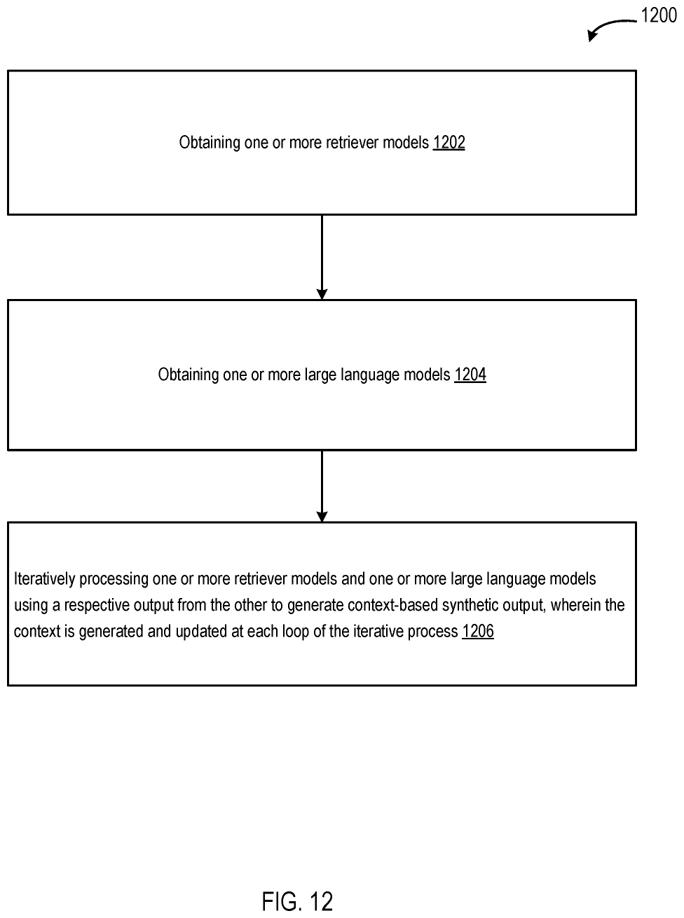

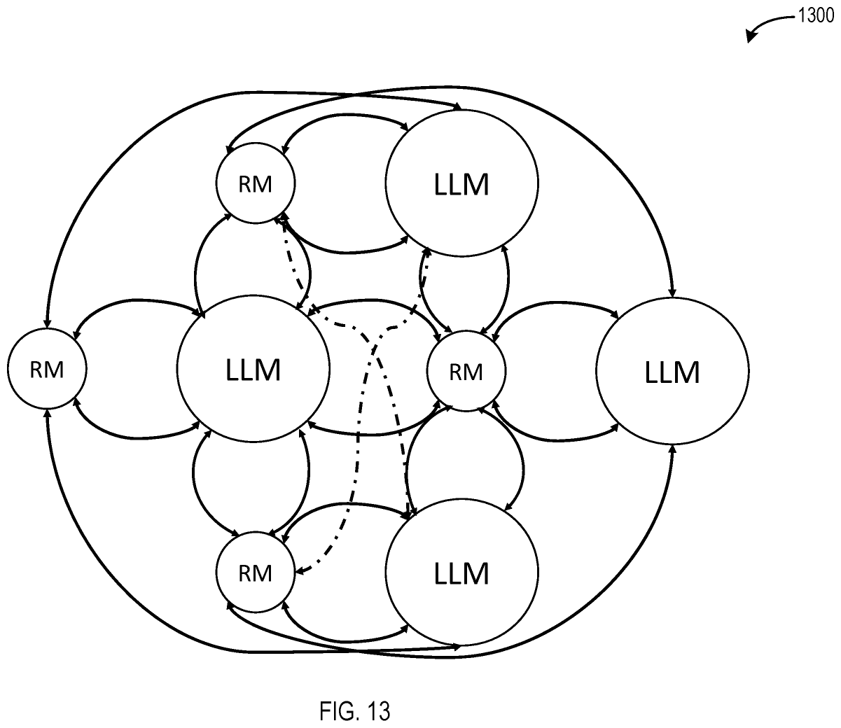

FIG. 12 depicts a flowchart 1200 of an example method of iterative context-based generative artificial intelligence using retriever models and large language model according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 1202, an iterative context-based generative artificial intelligence system (e.g., iterative context-based generative artificial intelligence system 102) obtains one or more retriever models. In some embodiments, a supervisor module (e.g., supervisor module 212) and/or one or more retriever modules (e.g., retriever modules 206 and/or 304) obtain the one or more retriever models. In step 1204, the iterative context-based generative artificial intelligence system obtains one or more large language models. In some embodiments, the supervisor module and/or a context-based comprehension module (e.g., context-based comprehension module 208 and/or 306) obtain the one or more large language models.

In step 1206, the iterative context-based generative artificial intelligence system iteratively processes one or more retriever models and one or more large language models using a respective output from the other to generate context-based synthetic output. For example, the synthetic output may comprise a unique output relative to any training dataset. The context may be generated and/or updated at each loop of the iterative process. In some embodiments, the supervisor module, context-based comprehension module, and the retriever module cooperate (e.g., communicate), and/or otherwise interact, to perform the iterative process.

In some embodiments, the iterative process includes an initial phase, an interim phase, a determination phase, an answer phase, an instruction phase, and a control phase. The initial phase may include, for example, obtaining an initial input, executing an initial loop of the iterative process using the one or more retriever models and the one or more large language models and the initial input to generate the context-based synthetic output. The interim phase may include, for example, executing one or more subsequent loops of the iterative process using the one or more retriever models and the one or more large language models to generate additional context-based synthetic output based on the initial loop of the iterative process. The answer phase may include, for example, the additional context-based synthetic output satisfying a validation criteria and outputting an answer based on the additional context-based synthetic output. The instruction phase may include, for example, generating one or more instructions sets based on the additional context-based synthetic output satisfying a validation criteria, and providing the generated one or more instruction sets to one or more other systems as system inputs. The control phase may include, for example, a supervisor module controlling execution of one or more loops of the iterative process. In some embodiments, the iterative processing includes a number of iterations limited by a maximum number of iterations threshold condition (e.g., a stopping condition).

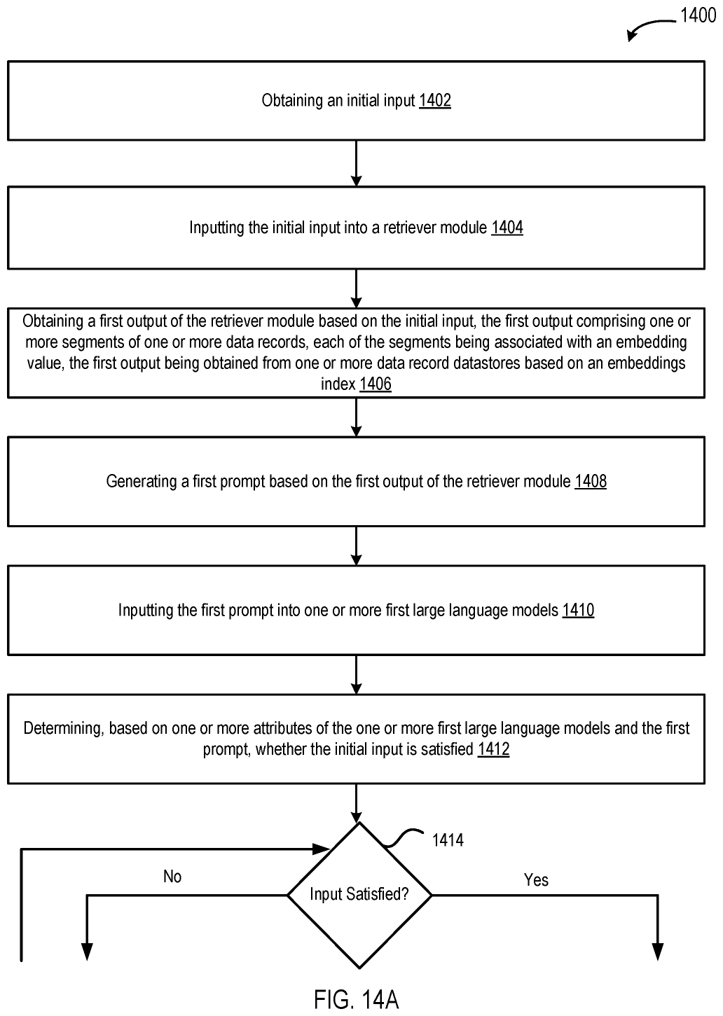

FIG. 13 depicts a diagram 1300 of an example graph of interactions between components of an iterative context-based generative artificial intelligence system according to some embodiments. More specifically, the diagram 1300 depicts interactions between multiple retriever models and large language models of an iterative context-based generative artificial intelligence system (e.g., iterative context-based generative artificial intelligence system 102) iteratively determining an answer to a query.

A supervisory orchestrator module or distributed supervision methodology can be used to manage the plurality of agents. A supervisory service, and/or otherwise control agents can include one or more large language models. The supervisory service can interpret inputs, generate subsequent instructions, select appropriate agents for handling queries and other inputs, and route the interpreted input to the selected agents. The supervisory service can also execute or delegate a variety of supervisory functions. The supervisory service and retrieval models may have a series of interactions for a complex multi-level request to iteratively develop context specific constructs that are responsive to the request. For example, in responding to a request, the supervisory service may infer a category of data is needed and request a retrieval model to retrieve data of the inferred category. The supervisory service can request an agent to synthesize the retrieved data and make a further inference for a different category or data source, and request a different retrieval model retrieve data for the further inferred category or data source. The interactive sequence of inference, retrieval, and synthesis between the enterprise comprehension modules and retrieval AI models can repeat numerous times (or multi-hops) to develop one or more relevant responses to a request. In some implementations, a supervisory agent can control, regulate, or limit the interactive sequence between the enterprise comprehension modules and retrieval AI models to ensure performance or confidence thresholds. The retrieval models can instruct the orchestration module for information virtualization and access control.

For example, the supervisory service may implement stopping conditions to prevent a comprehension module from stalling in an endless loop during an iterative context-based generative artificial intelligence process. The supervisory service may also include one or more other types of models to process (e.g., transform) non-text input. Other models (e.g., other machine learning models, translation models) may also be included in addition to, or instead of, the large language models for some or all of the agents and/or modules described herein.

Example aspects include systems and methods to implement machine learning models such as multimodal models, large language models (LLMs), and other machine learning models with enterprise grade integrity including access control, traceability, anti-hallucination, and data-leakage protections. Machine learning models can include some or all of the different types or modalities of models described herein (e.g., multimodal machine learning models, large language models, data models, statistical models, audio models, visual models, audiovisual models, etc.). It is noted that the above-described functionality has been provided by way of non-limiting example and other techniques may be used to generate queries and commands. For example, in additional or alternative implementations using multimodal or generative pre-trained transformers, which is an autoregressive language model that uses deep learning to produce human-like text, may be used to generate a query from the search input (i.e., without use of a seed bank). To illustrate, suppose the search input was “What are the riskiest motor actuators at Tinker?”. As in the technique described above, the search input may be subjected to entity extraction and mapping, which would result in an entity matched search input of “What are the riskiest WUC 11AAF at Location AFB0123 ?.” Input is subjected to embedding and vectorization, with a large language model is used for query generation the entity matched search input may be provided to the generative multimodal or large language model algorithm to generate the query. In such an implementation, a generative multimodal algorithm may be provided with contextual information, such as a schema of metadata defining table headers, field descriptions, and joining keys, which may be used to retrieve the search results. For example, the schema may be used to translate the entity matched search input into a query (e.g., an SQL query).

The system may leverage characteristics of a model driven architecture, which represent system objects (e.g., components, functionality, data, etc.) using rich and descriptive metadata, to dynamically generate queries for conducting searches across a wide range of data domains (e.g., documents, tabular data, insights derived from AI applications, web content, or other data sources). Furthermore, the query modules of embodiments may be particularly well suited to searches involving type systems, which expose objects through metadata. Accordingly, the query modules disclosed herein represent an improvement in the field of query modules and provide a mechanism for rapidly deploying search functionality across a wide variety of data domains relative to existing query modules, which are typically limited with respect to their searchable data domains (e.g., web query modules are limited to web content, file system query modules are limited to searches of file system, and so on).

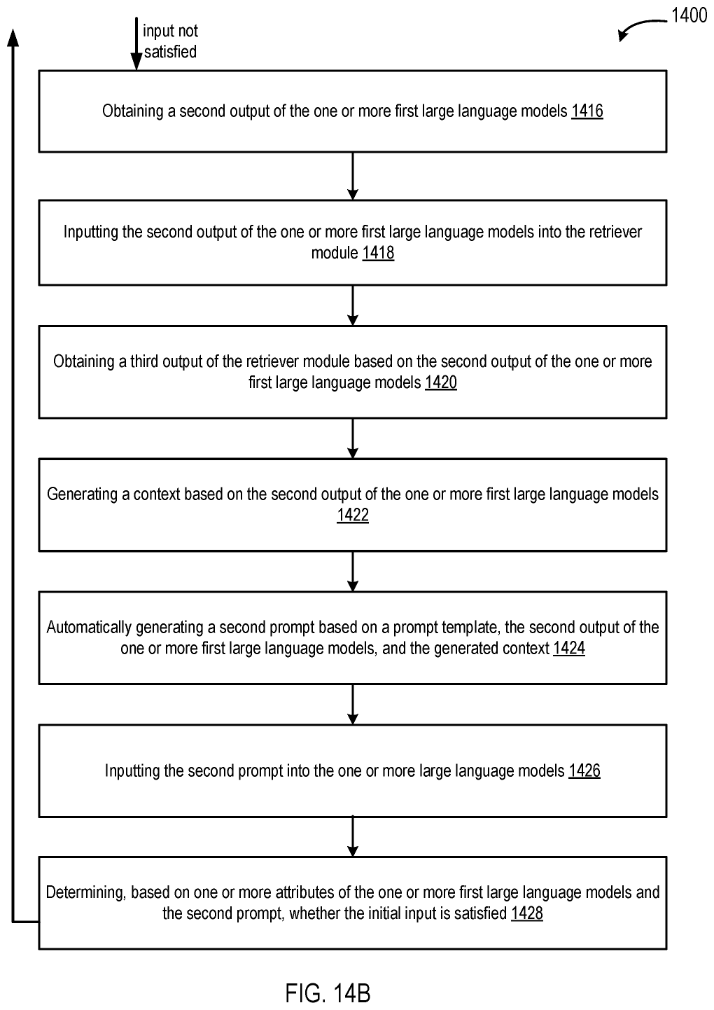

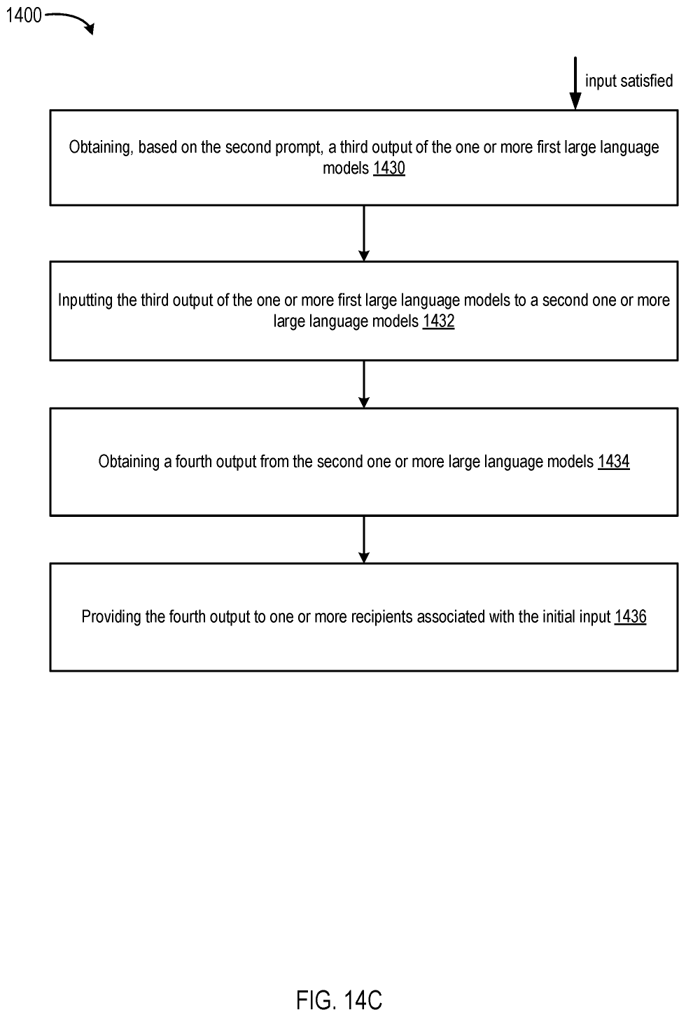

FIGS. 14A-C depict a flowchart 1400 of an example method of iterative context-based generative artificial intelligence according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 1402, an iterative context-based generative artificial intelligence system (e.g., iterative context-based generative artificial intelligence system 102) obtains an initial input (e.g., complex input 302). In some embodiments, an interface module (e.g., interface module 204) obtains the initial input (e.g., from one or more users and/or systems). In some embodiments, the initial input comprises a user input, system input, instruction set (e.g., an executable instruction set), and/or a natural language input.

In step 1404, the iterative context-based generative artificial intelligence system inputs the initial input into a retriever module (e.g., retriever module 304 and/or 206). In some embodiments, a supervisor module (e.g., supervisor module 212) inputs the initial input into a retriever module (e.g., an retriever module selected by the supervisor module) and/or an supervisor module instructs the interface module to provide the initial input the retriever module. In some embodiments, the retriever module comprises one or more neural network transformer-based machine learning models. In some embodiments, retriever module comprises any of one or more data retriever models, one or more database retriever models, and one or more internet retriever models.

In step 1406, the iterative context-based generative artificial intelligence system obtains a first output of the retriever module based on the initial input. The first output may comprise one or more segments of one or more data records. Each of the segments may be associated with an embedding value, and the first output may be obtained from one or more data record datastores based on an embeddings index (e.g., embeddings datastore 260). In some embodiments, a query and rational generator (e.g., query and rationale generator 312) and/or context-based comprehension module (e.g., context-based comprehension module 208 and/or 306) obtains the first output from the retriever module. In some embodiments, the query and rational generator comprises the one or more first large language models.

In step 1408, the iterative context-based generative artificial intelligence system generates a first prompt based on the first output of the retriever module. In some embodiments, a prompt generation module (e.g., prompt generation module 210) generates the prompt. In step 1410, the iterative context-based generative artificial intelligence system inputs the first prompt into the one or more first large language models. In some embodiments, the prompt generation module, query and rationale generator, and/or the context-based comprehension module input the first prompt into one more first large language models. For example, the one or more large language models may comprise portions of the query and rationale generator and the context-based comprehension module.

In step 1412, the iterative context-based generative artificial intelligence system determines, based on one or more attributes of the one or more first large language models and the first prompt, whether the initial input is satisfied. In some embodiments, the context-based comprehension module and/or the first large language models determine whether the initial input is satisfied. If the input is not satisfied, the iterative context-based generative artificial intelligence system performs and/or repeats steps 1416-1428 until the initial input is satisfied and/or if a stopping condition is satisfied (e.g., a maximum number of repetitions or iterations). If the input is satisfied, the iterative context-based generative artificial intelligence system performs steps 1430-1436.

In step 1416, the iterative context-based generative artificial intelligence system obtains a second output of the one or more first large language models. In some embodiments, the query and rational generator obtains the second output. In step 1418, the iterative context-based generative artificial intelligence system inputs the second output of the one or more first large language models into the retriever module. In some embodiments, the query and rational generator inputs the second output of the first large language model into the retriever module. In step 1420, the iterative context-based generative artificial intelligence system obtains a third output of the retriever module based on the second output of the one or more first large language models. In some embodiments, the query and rational generator obtains the third output of the retriever module.

In step 1422, the iterative context-based generative artificial intelligence system generates a context based on the second output of the one or more first large language models. In some embodiments, the query and rational generator generates the context. In some embodiments, the context includes a concatenation of a portion of the segments of any of the outputs. In step 1424, the iterative context-based generative artificial intelligence system automatically (e.g., without requiring user input) generates a second prompt based on a prompt template, the second output of the one or more first large language models, and the generated context. In some embodiments, the prompt generation module and/or the query and rational generator generate the prompt. In some embodiments, the prompt generation module comprises a portion of the query and rational generator.

In step 1426, the iterative context-based generative artificial intelligence system inputs the second prompt into the one or more first large language models. In some embodiments, the prompt generation module inputs the second prompt into one or more first large language models. In step 1428, the iterative context-based generative artificial intelligence system determines, based on one or more attributes of the one or more first large language models and the second prompt, whether the initial input is satisfied. In some embodiments, the context-based comprehension module and/or the one or more large language models determine whether the initial input is satisfied. In step 1430, the iterative context-based generative artificial intelligence system obtains, based on the second prompt, a third output of the one or more first large language models.

In step 1432, the iterative context-based generative artificial intelligence system inputs the third output of the one or more first large language models to one or more second large language models (e.g., of the answer generator 320). In some embodiments, the one or more first large language models inputs the third output to the one or more second large language models. In step 1434, the iterative context-based generative artificial intelligence system obtains a fourth output (e.g., output 314) from the second one or more large language models.

In step 1436, the iterative context-based generative artificial intelligence system provides the fourth output to one or more recipients (e.g., users and/or systems) associated with the initial input (e.g., that generated and/or provided the initial input). In some embodiments, the iterative context-based generative artificial intelligence system can terminate the method 1400 based on a stopping condition (e.g., a maximum number of iterations) before the initial input is satisfied.

In some embodiments, the iterative context-based generative artificial intelligence system can pre-process the initial input using one or more other large language models. For example, one or more large language models of the supervisor module may transform the query into multiple query segments, and then route each segment to a different retriever module for processing. The initial query may comprise a natural language query, for example, and the transformed query may comprise another large language model query, an instruction set (e.g., an SQL query) and/or other type of query than can be processed by the appropriate retriever module.

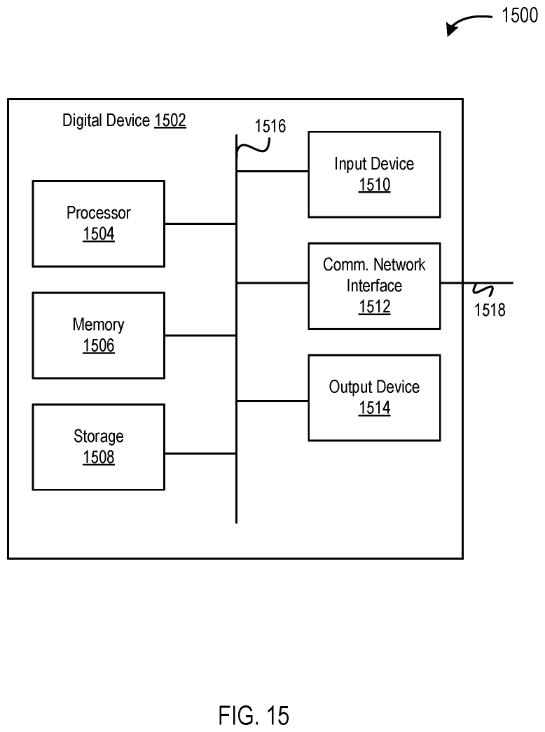

FIG. 15 depicts a diagram 1500 of an example of a computing device 1502. Any of the systems, engines, datastores, and/or networks described herein may comprise an instance of one or more computing devices 1502. In some embodiments, functionality of the computing device 1502 is improved to the perform some or all of the functionality described herein. The computing device 1502 comprises a processor 1504, memory 1506, storage 1508, an input device 1510, a communication network interface 1512, and an output device 1514 communicatively coupled to a communication channel 1516. The processor 1504 is configured to execute executable instructions (e.g., programs). In some embodiments, the processor 1504 comprises circuitry or any processor capable of processing the executable instructions.

The memory 1506 stores data. Some examples of memory 1506 include storage devices, such as RAM, ROM, RAM cache, virtual memory, etc. In various embodiments, working data is stored within the memory 1506. The data within the memory 1506 may be cleared or ultimately transferred to the storage 1508. The storage 1508 includes any storage configured to retrieve and store data. Some examples of the storage 1508 include flash drives, hard drives, optical drives, cloud storage, and/or magnetic tape. Each of the memory system 1506 and the storage system 1508 comprises a computer-readable medium, which stores instructions or programs executable by processor 1504.

The input device 1510 is any device that inputs data (e.g., mouse and keyboard). The output device 1514 outputs data (e.g., a speaker or display). It will be appreciated that the storage 1508, input device 1510, and output device 1514 may be optional. For example, the routers/switchers may comprise the processor 1504 and memory 1506 as well as a device to receive and output data (e.g., the communication network interface 1512 and/or the output device 1514).

The communication network interface 1512 may be coupled to a network (e.g., network 108) via the link 1518. The communication network interface 1512 may support communication over an Ethernet connection, a serial connection, a parallel connection, and/or an ATA connection. The communication network interface 1512 may also support wireless communication (e.g., 802.11 a/b/g/n, WiMax, LTE, Wi-Fi). It will be apparent that the communication network interface 1512 may support many wired and wireless standards.

It will be appreciated that the hardware elements of the computing device 1502 are not limited to those depicted in FIG. 15. A computing device 1502 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1504 and/or a co-processor located on a GPU (i.e., NVidia).

Example types of computing devices and/or processing devices include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application specific integrated circuits (ASICs), field programmable gate arrays (FPGAs), or discrete circuitry.

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Aspects of this disclosure can be used with a framework for unifying information access methodologies and application operations across legacy and new enterprise applications and growing magnitude of data sources in enterprise environments. Iterative context-based generative artificial intelligence can be used with systems and methods for harmonizing access to information and increasing availability to complex application operations while respecting enterprise security and privacy controls. An example framework described uses machine learning techniques to navigate enterprise information and applications, comprehend organization specific context queues (e.g., acronyms, nicknames, jargon, etc.), and locate information most relevant to a request. Iterative context-based generative artificial intelligence can be used to lower learning curve and reduce the steps a user must perform to access information thereby democratizing usage of information currently blocked by complexities and domain expertise required by conventional enterprise information system.

In some embodiments, the systems, methods, and non-transitory computer readable medium are further configured to perform (e.g., for each iteration) generating a respective context associated with a respective subsequent output of the first large language model; and determining, by the first large language model based on the respective context, whether the respective subsequent output satisfies the initial query. In some embodiments, the systems, methods, and non-transitory computer readable medium are further configured to perform obtaining at least a portion of the one or more data records based on the initial query; and generating an initial prompt based on the at least a portion of the one or more data records, wherein the first large language model determines whether the respective subsequent output of the first large language model satisfies initial query based on the initial prompt. In some embodiments, the systems, methods, and non-transitory computer readable medium are further configured to perform obtaining at least another portion of the one or more data records based on the respective subsequent output of the first large language model; and generating a subsequent prompt based on the respective subsequent output of the first large language model and the respective context, wherein the first large language model determines whether the respective subsequent output satisfies the initial query based on the subsequent prompt. In some embodiments, each portion of the at least a portion of the one or more data records is associated with an embedding value, and wherein the at least a portion of the one or more data records is obtained based on the embedding value and an embedding index.

In some embodiments, a retriever module obtains the at least a portion of the one or more data records, and wherein the retriever module provides the at least a portion of the one or more data records to the first large language model. In some embodiments, the first large language model is different from the second large language model. In some embodiments, the first large language model is the same large language model as the second large language model. In some embodiments, the retriever modules comprise a retriever model. In some embodiments, the retriever module comprises a machine learning model. In some embodiments, the initial query comprises any of a natural language query, an instruction set, a user query, or a system query. In some embodiments, the systems, methods, and non-transitory computer readable medium are further configured to perform generating a subsequent query based on the respective subsequent output of the first large language model and respective context, wherein the first large language model determines whether the respective subsequent output of the first large language model satisfies the initial query based on the subsequent query.

In some embodiments, the respective context comprises any of a concatenation of a plurality of different portions of any of the outputs of the first large language model. In some embodiments, the systems, methods, and non-transitory computer readable medium are further configured to include a stopping condition configured to terminate the iterative determinations when the stopping condition is satisfied prior to the initial input being satisfied. In some embodiments, the systems, methods, and non-transitory computer readable medium are further configured to perform terminating the iterative determinations when the stopping condition is satisfied prior to the initial input being satisfied. In some embodiments, the stopping condition comprises a maximum number of iterations. In some embodiments, the systems, methods, and non-transitory computer readable medium are further configured to perform pre-processing, using another large language model, the initial input, wherein the first large language model determines whether the initial input is satisfied based on the pre-processed initial input.

Various embodiments of the present disclosure include systems, methods, and non-transitory computer-readable media configured to obtain an initial query. Determine an initial output of a first large language model based on the initial query. Determine, using the first large language model, whether the initial output of the first large language model satisfies the initial query. Iteratively determine, in response to the initial query not being satisfied, whether one or more subsequent outputs of the first large language model satisfies the initial query. Terminate, in response to a stopping condition being satisfied and the initial query not being satisfied, the iterative determinations, and provide a notification indicating the initial query has not been satisfied.

Various embodiments of the present disclosure include systems, methods, and non-transitory computer-readable media configured to generate, by one or more large language models, context-based synthetic output based on retrieved information from one or more retriever models, wherein the one or more retriever models retrieve information from various data sources. Provide to the one or more large language models one or more additional retrieved information by the one or more retriever models to generate one or more additional context-based synthetic output until context validation criteria is satisfied, wherein the one or more additional retrieved information is based on the context-based synthetic output or the one or more additional context-based synthetic output, and output, in response to a selected additional context-based synthetic output satisfying the context validation criteria, the selected additional context-based synthetic output as an answer to a generative process. In some embodiments, the providing one or more additional retrieved information is repeated by different retriever models of the one or more retriever models and different large language models of the large language models. In some embodiments, the context-based synthetic output is a natural language output from a loop of an iterative generative process comprising a concatenation of data record segments and fails to satisfy the context validation criteria based on any of a termination condition, an initial input, and one or more quality rules of the one or more large language models. In some embodiments, the additional context-based synthetic output is a subsequent natural language output from a subsequent loop of the iterative generative process comprising a concatenation of data record segments and satisfies the context validation criteria based on any of a termination condition, an initial input, and one or more quality rules of the one or more large language models.

In some embodiments, a first large language model of the one or more large language models generates the context-based synthetic output, and a different large language model of the one or more large language models generates the one or more additional context-based synthetic output. In some embodiments, a first retriever model of the one or more retriever models retrieves the information, and a different retriever model of the one or more retriever models retrieves the additional retrieved information. In some embodiments, the selected additional context-based synthetic output satisfying the context validation criteria is different from the context-based synthetic output. In some embodiments, the context validation criteria include one or more of large language model rules, large language model conditions, context-based comprehension module rules, context-based comprehension module conditions, and a context quality threshold condition. In some embodiments, the generating the context-based synthetic output is based on retrieved information and natural language processing input.

Various embodiments of the present disclosure include systems, methods, and non-transitory computer-readable media configured to generate an initial prompt for a context-based comprehension module. Determine context-specific criteria to satisfy the initial input. Iteratively process retriever models large and language models to satisfy the determined criteria, wherein the retriever models access context specific data sources and the large language models are trained on context specific data.

In some embodiments, the iteratively processing comprises generating one or more interim prompt templates, wherein the one or more interim prompt templates include rationales and contexts which inform subsequent iterations. In some embodiments, the systems, methods, and non-transitory computer readable medium are further configured to perform determining one of the subsequent iterations satisfies a condition; and generating another prompt template for an answer phase based on the determination. In some embodiments, satisfying the determined criteria comprises determining if enough information meets a context threshold.

Various embodiments of the present disclosure include systems, methods, and non-transitory computer-readable media configured to define conditions or functions that determine if more information is needed to satisfy the initial input or if there is enough information to satisfy the initial input. Generate multiple prompt templates comprising prompts that include rationales and contexts to inform subsequent iterations. Select one or more retrieve models and one or more large language models, wherein any of the retriever models and the one or more large language models associated with a particular domain of a set of different domains. Iteratively process the one or more retriever models and the one or more large language models using the respective output from the other to generate a context-based synthetic output. In some embodiments, iteratively processing includes an initial phase, an interim phase, a determination phase, an answer phase, an instruction phase, and a control phase. In some embodiments, a supervisor module to execute and/or otherwise process various supervisory functions. In some embodiments, an interface module to receive inputs and transmit outputs.

Various embodiments of the present disclosure include systems, methods, and non-transitory computer-readable media configured to iteratively process one or more retriever models and one or more large language models using a respective output from the other to generate context-based synthetic output, wherein the context is generated and updated at each loop of the iterative process. In some embodiments, iteratively processing includes an initial phase, an interim phase, a determination phase, an answer phase, an instruction phase, and a control phase. In some embodiments, the initial phase comprises obtaining an initial input, executing an initial loop of the iterative process using the one or more retriever models and the one or more large language models and the initial input to generate the context-based synthetic output. In some embodiments, the interim phase comprises executing one or more subsequent loops of the iterative process using the one or more retriever models and the one or more large language models to generate additional context-based synthetic output based on the initial loop of the iterative process.

In some embodiments, the answer phase comprises the additional context-based synthetic output satisfying a validation criteria and outputting an answer based on the additional context-based synthetic output. In some embodiments, the instruction phase comprises generating one or more instructions sets based on the additional context-based synthetic output satisfying a validation criteria, and providing the generated one or more instruction sets to one or more other systems as system inputs. In some embodiments, the control phase comprises a supervisor agent controlling execution of one or more loops of the iterative process. In some embodiments, the context-based synthetic output comprises a unique output relative to any training dataset. In some embodiments, the iterative processing includes a number of iterations limited by a maximum number of iterations threshold condition. In some embodiments, the systems, methods, and non-transitory computer readable medium are further configured to perform (e.g., for each iteration) generating a respective context associated with a respective subsequent output of the first large language model; and determining, by the first large language model based on the respective context, whether the respective subsequent output satisfies the initial query. Various embodiments of the present disclosure include systems, methods, and non-transitory computer-readable media configured to obtain an initial query. Determine an initial output of a first large language model based on the initial query. Determine, using the first large language model, whether the initial output of the first large language model satisfies the initial query. Iteratively determine, in response to the initial query not being satisfied, whether one or more subsequent outputs of the first large language model satisfies the initial query. Terminate, in response to a stopping condition being satisfied and the initial query not being satisfied, the iterative determinations, and provide a notification indicating the initial query has not been satisfied.

Various embodiments of the present disclosure include systems, methods, and non-transitory computer-readable media configured to generate, by one or more large language models, context-based synthetic output based on retrieved information from one or more retriever models, wherein the one or more retriever models retrieve information from various data sources. Provide to the one or more large language models one or more additional retrieved information by the one or more retriever models to generate one or more additional context-based synthetic output until context validation criteria is satisfied, wherein the one or more additional retrieved information is based on the context-based synthetic output or the one or more additional context-based synthetic output, and output, in response to a selected additional context-based synthetic output satisfying the context validation criteria, the selected additional context-based synthetic output as an answer to a generative process. Various embodiments of the present disclosure include systems, methods, and non-transitory computer-readable media configured to obtain an initial input. Input the initial input into a retriever module. Obtain a first output of the retriever module based on the initial input, the first output comprising one or more segments of one or more data records, each of the segments being associated with an embedding value, the first output being obtained from one or more data record datastores based on an embeddings index. Generate a first prompt based on the first output of the retriever module. Input the first prompt into one or more first large language models. Determine, based on one or more attributes of the one or more first large language models and the first prompt, whether the initial input is satisfied. In response to determining that the initial input is not satisfied: obtain a second output of the one or more first large language models; input the second output of the one or more first large language models into the retriever module; obtaining a third output of the retriever module based on the second output of the one or more first large language models; generate a context based on the second output of the one or more first large language models; automatically generate a second prompt based on a prompt template, the second output of the one or more first large language models, and the generated context; input the second prompt into the one or more large language models; and determine, based on one or more attributes of the one or more first large language models and the second prompt, whether the initial input is satisfied. In response to determining that the initial input is satisfied: obtain, based on the second prompt, a third output of the one or more first large language models; input the third output of the one or more first large language models to a second one or more large language models; obtain a fourth output from the second one or more large language models; and provide the fourth output to one or more recipients associated with the initial input.

In some embodiments, the retriever module comprises one or more neural network transformer-based machine learning models. In some embodiments, the retriever module comprises any of one or more data retriever models, one or more database retriever models, and one or more internet retriever models. In some embodiments, the initial input comprises any of a user input or system input. In some embodiments, the first input comprises an instruction set. In some embodiments, the instruction set comprises a natural language query. In some embodiments, the context includes a concatenation of a portion of the segments of any of the outputs. In some embodiments, the systems, methods, and non-transitory computer readable medium further comprise a stopping condition that terminates the process when satisfied. In some embodiments, the stopping condition comprises a maximum number of iterations. In some embodiments, the systems, methods, and non-transitory computer readable medium further comprise another large language model that pre-processes the first input prior to being input into the retriever module.

In some embodiments, a system may comprise one or more processing devices and one or more memory devices operably coupled to the one or more processing devices, the one or more memory devices storing executable code effective to cause the one or more processing devices to perform functionality described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The present invention(s) are described above with reference to example embodiments. It will be apparent to those skilled in the art that various modifications may be made, and other embodiments may be used without departing from the broader scope of the present invention(s). Therefore, these and other variations upon the example embodiments are intended to be covered by the present invention(s).

What is claimed is:

1. A method comprising:
generating, using a multimodal model, a response to a query;
iteratively determining, in response to the query whether one or more subsequent outputs of the multimodal model satisfies the query;
generating a respective context associated with a respective output of the multimodal model; and
determining, by the multimodal model based on the respective context, whether the respective subsequent output satisfies the query.

2. The method of claim 1, further comprising
obtaining at least a portion of one or more data records based on the query;
generating an initial prompt based on the at least a portion of the one or more data records; and
wherein the multimodal model determines whether the respective subsequent output of the multimodal model satisfies the query based on the prompt.

3. The method of claim 2, further comprising:
obtaining at least another portion of the one or more data records based on the respective subsequent output of the multimodal model;
generating a subsequent prompt based on the respective subsequent output of the multimodal model and the respective context; and
wherein the multimodal model determines whether the respective subsequent output satisfies the query based on the subsequent prompt.

4. The method of claim 3, wherein each portion of the at least a portion of the one or more data records is associated with an embedding value, and wherein the at least a portion of the one or more data records is obtained based on the embedding value and an embedding index.

5. The method of claim 4, further comprising:
obtaining, by a retriever module, the at least a portion of the one or more data records, and wherein the retriever module provides the at least a portion of the one or more data records to the multimodal model.

6. The method of claim 5, wherein the retriever module comprises a multimodal machine learning model.

7. The method of claim 1, wherein the query comprises any of a natural language query, an instruction set, a user query, or a system query.

8. The method of claim 1, further comprising:
generating a subsequent query based on the respective subsequent output of the multimodal model and respective context; and
wherein the multimodal model determines whether the respective subsequent output of the multimodal model satisfies the query based on the subsequent query.

9. The method of claim 1, wherein the respective context comprises any of a concatenation of a plurality of different portions of any of the outputs of the multimodal model.

10. The method of claim 1, further comprising a stopping condition configured to terminate the iterative determinations when the stopping condition is satisfied prior to the query being satisfied.

11. The method of claim 10, wherein the stopping condition comprises a maximum number of iterations.

12. The method of claim 1, further comprising:
pre-processing, using another multimodal model, the query; and
wherein the multimodal model determines whether the query is satisfied based on the pre-processed query.

13. A system comprising one or more processing devices and one or more memory devices operably coupled to the one or more processing devices, the one or more memory devices storing executable code effective to cause the one or more processing devices to:
generate, using a large language model, a response to a query;
iteratively determine, in response to a query whether one or more subsequent outputs of the large language model satisfies the query;
generate a respective context associated with a respective output of the large language model; and
determine, by the large language model based on the respective context, whether the respective subsequent output satisfies the query.

14. The system of claim 13, wherein the one or more processing devices are further configured to:
obtain at least a portion of one or more data records based on the query;
generate an initial prompt based on the at least a portion of the one or more data records; and
wherein the large language model determines whether the respective subsequent output of the large language model satisfies the query based on the prompt.

15. The system of claim 14, wherein the one or more processing devices are further configured to:
obtaining at least another portion of the one or more data records based on the respective subsequent output of the large language model;
generating a subsequent prompt based on the respective subsequent output of the large language model and the respective context; and
wherein the large language model determines whether the respective subsequent output satisfies the query based on the subsequent prompt.

16. The system of claim 14,
wherein each portion of the at least a portion of the one or more data records is associated with an embedding value, and wherein the at least a portion of the one or more data records is obtained based on the embedding value and an embedding index; and
wherein a retriever module obtains the at least a portion of the one or more data records, and
wherein the retriever module provides the at least a portion of the one or more data records to the large language model.

17. A non-transitory computer readable medium comprising instructions that when executed cause at least one processor to:
generate, using a large language model, a response to a query;
iteratively determine, in response to a query whether one or more subsequent outputs of the large language model satisfies the query;
generate a respective context associated with a respective output of the large language model; and
determine, by the large language model based on the respective context, whether the respective subsequent output satisfies the query.

18. The non-transitory computer readable medium of claim 17, further configured to:
obtain at least a portion of one or more data records based on the query; and
generate an initial prompt based on the at least a portion of the one or more data records;
wherein the large language model determines whether the respective subsequent output of the large language model satisfies the query based on the prompt.
